(19) United States
(12) Patent Application Publication
(10) Pub. No.: US 2026/0128186 A1
(43) Pub. Date: May 7, 2026

(54) SYSTEMS AND METHODS FOR ENHANCED TRITIUM BURN EFFICIENCY IN FUSION ENERGY SYSTEMS

(71) Applicant: The Trustees of Princeton University, Princeton, NJ (US)

(72) Inventors: Jason Parisi, Lawrence Township, NJ (US); Ahmed Diallo, Plainsboro Center, NJ (US); Jacob Schwartz, Princeton Junction, NJ (US)

(73) Assignee: The Trustees of Princeton University, Princeton, NJ (US)

(21) Appl. No.: 19/382,908

(22) Filed: Nov. 7, 2025

Related U.S. Application Data
(60) Provisional application No. 63/717,530, filed on Nov. 7, 2024.

(51) Int. Cl. G21D 3/00; G21B 1/15

(52) U.S. Cl. CPC G21D 3/001; G21B 1/15

(57) ABSTRACT

In various aspects a method for optimizing the operation of a fusion plant is provided. The method may include selecting a preferred objective. The objective may be chosen to enhance the operation of a plant with a plasma. The plasma may include a deuterium-tritium fuel. The method may also include determining a target deuterium-tritium ratio based on the preferred objective. The method may also include polarizing at least a portion of the deuterium-tritium fuel according to the preferred objective before the deuterium-tritium fuel is injected into a fusion plasma.

### CROSS-REFERENCE TO RELATED APPLICATIONS

The present application claims priority to U.S. Provisional Patent Application 63/717,530, filed Nov. 7, 2024, the contents of which are incorporated by reference herein in its entirety.

### STATEMENT REGARDING FEDERALLY SPONSORED RESEARCH OR DEVELOPMENT

This invention was made with government support under Grant No. DE-AC02-09CH11466 awarded by the Department of Energy. The government has certain rights in the invention.

### TECHNICAL FIELD

The present disclosure is drawn to systems and methods for optimizing the operation of a fusion plant.

### BACKGROUND

This section is intended to introduce the reader to various aspects of the art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Deuterium-tritium (D-T) is widely considered the most feasible fuel for first-generation fusion power plants due to its high reactivity at experimentally realizable temperatures and the large energy release per fusion reaction. However, tritium is scarce because it has a half-life of 12.3 years and is hard to produce in large quantities with current technology. Due to tritium scarcity, D-T plants are designed to be tritium self-sufficient. This is achieved by neutron capture reactions with lithium in the blanket surrounding the core.

In order for a power plant to be tritium self-sufficient, the tritium-breeding ratio (TBR), which measures the ratio of tritium production to burn-up, must exceed a minimum value. It has been reported that the tritium fractional burn-up is among the most important, if not the most important, variable for achieving a high TBR. A closely related quantity used in this work is the tritium burn efficiency (TBE), the ratio of the tritium burn rate to the tritium injection rate. Improvements in the TBE can lessen requirements for other key tritium self-sufficiency parameters such as the startup inventory, the tritium doubling time, and tritium loss fractions. A high TBE could significantly lower the cost and regulation complexity of a fusion plant.

### BRIEF SUMMARY

Various deficiencies in the prior art are addressed below by the disclosed systems and methods for optimizing the operation of a fusion plant.

In various aspects, a method for optimizing the operation of a fusion plant may be provided. The method may include selecting a preferred objective. The preferred objective may be chosen to enhance the operation of a plant with a plasma comprised of deuterium-tritium fuel. The method may also include determining a target deuterium-tritium ratio based on the preferred objective. The method may also include polarizing at least a portion of the deuterium-tritium fuel according to the preferred objective before the deuterium-tritium fuel is injected into a fusion plasma.

In some embodiments, the preferred objective may be one of tritium burn efficiency, fusion power density, minimum tritium startup inventory, or desired power output, or a combination thereof. In some embodiments, the preferred objective may be the tritium fuel injection fraction and/or spin polarization.

In some embodiments, the preferred objective may be minimum startup inventory. The preferred minimum startup inventory may be between 1 kg and 0.01 kg. The preferred tritium burn efficiency may be between 10% and 40%.

In some embodiments, the target deuterium-tritium ratio may be 55%-65% by number deuterium to 35%-45% by number tritium. In some embodiments, the target deuterium-tritium ratio may be (i) 57% by number deuterium and 43% by number tritium or (ii) 61% by number deuterium to 39% by number tritium.

In some embodiments, the nuclei of at least some deuterium and/or tritium may be polarized. At least a quarter of the deuterium-tritium fuel may be polarized. At least three-fourths of the deuterium-tritium fuel may be polarized. At least 95% of the deuterium-tritium fuel may be polarized.

In various aspects, a fusion fuel made by the process described herein may be provided.

In various aspects, a system may be provided. The system may include a non-transitory computer-readable medium carrying instructions to be executed by at least one processor. The instructions may be configured to perform a method for optimizing a fusion power plant.

The method may include receiving a preferred optimization objective. The method may include improving a deuterium-tritium fuel fraction, according to the preferred optimization objective.

Improving the deuterium-tritium fuel may include determining a deuterium-tritium fueling mix. Improving the deuterium-tritium fuel may include determining target spin polarizations for injected deuterium fuel and for injected tritium fuel.

In some embodiments, the preferred optimization objective may be at least one of tritium burn efficiency, fusion power density, and minimum startup inventory. In some embodiments, the preferred optimization objective may be one of tritium fuel injection or spin polarization.

In some embodiments, the system may further include means for adjusting spin polarization of the deuterium-tritium fuel to achieve the preferred optimization objective.

### BRIEF DESCRIPTION OF FIGURES

The accompanying drawings, which are incorporated in and constitute a part of this specification, illustrate embodiments of the present disclosure and, together with a general description of the present disclosure given above, and the detailed description of the embodiments given below, serve to explain the principles of the present disclosure.

FIG. 1 shows a flow diagram of an embodiment of a method for optimizing the operation of a fusion plant.

FIG. 2 shows a graphical representation of tritium self-sufficiency and fusion power parameters of an ARC-like device for three cases.

FIG. 3 shows a table of quantities used in the present disclosure.

FIG. 4 shows a graphical representation of polarization cross-section multiplier Aⱼ versus deuterium spin difference D₁-D₋₁ and tritium spin probability T_{1/2}.

FIG. 5A shows a graphical representation of tritium core fraction

$${f}_{T}^{co}$$

versus enclosed burn fraction ƒ_{burn} for three different tritium injection fraction

$$( {F}_{T}^{in} )$$

values.

FIG. 5B shows a graphical representation of tritium burn efficiency (TBE) versus tritium separatrix fraction

$$( {f}_{T}^{sep} ) and {F}_{T}^{in} .$$

FIG. 6 shows a schematic of the particle flows in a configuration with higher tritium burn efficiency (top) and a nominal configuration (bottom).

FIG. 7A shows a graphical representation of tritium burn efficiency (TBE) as a function of tritium injection fraction

$${F}_{T}^{i n}$$

for different ƒ_{He,div} Values.

FIG. 7B shows a graphical representation of the ratio of TBE for two tritium input fractions

$${F}_{T}^{i n}$$

as a function of the ratio of helium to unburned hydrogen fuel in the divertor ƒ_{He,div}.

FIG. 8 shows a graphical representation of the spin-polarization multiplier [symbol] Aⱼ as a function of the core tritium density fraction.

FIG. 9A shows a graphical representation of fusion power multiplier p_{Δ} maximized over all

$${F}_{T}^{i n}$$

values versus tritium burn efficiency (TBE) and NAⱼ.

FIG. 9B shows a graphical representation of fusion power multiplier p_{Δ} maximized over all

$${F}_{T}^{i n}$$

values versus tritium burn efficiency (TBE) for several NAⱼ values.

FIG. 9C shows a graphical representation of various tritium and helium density and flow rate fractions versus TBE.

FIG. 10A shows a graphical representation of TBE versus typical tritium core fraction

$${\tilde{f}}_{T}^{c o}$$

for a range of spin-polarization multipliers NAⱼ and fusin power multipliers p_{Δ} values.

FIG. 10B shows a graphical representation of fusion power multipliers p_{Δ} versus typical tritium core fraction

$${\tilde{f}}_{T}^{c o}$$

for a range of spin-polarization multipliers NAⱼ and TBE values.

FIG. 11 shows a graphical representation of tritium fraction for which the fusion power density is maximized

$${f}_{T , max}^{c o}$$

versus TBE.

FIGS. 12A and 12B show graphical representations of the maximum power multiplier p_{Δ} versus spin-polarization multiplier NAⱼ and relative helium pumping speed Σ for two TBE values.

FIGS. 13A and 13B show graphical representations of maximum tritium burn efficiency (TBE) for power multiplier versus spin-polarization multiplier [symbol] Aⱼ and relative helium pumping speed Σ.

FIG. 14A shows a graphical representation of maximum tritium burn efficiency (TBE) for power multiplier p_{Δ}=0.95 versus core tritium fraction

$${f}_{T}^{c o}$$

and relative helium pumping speed with cross-section multiplier value NA_{J}=1.00.

FIG. 14B shows a graphical representation of maximum tritium burn efficiency (TBE) for power multiplier p_{Δ}=0.95 versus core tritium fraction

$${f}_{T}^{c o}$$

and relative helium pumping speed with cross-section multiplier value NA_{J}=1.25.

FIG. 14C shows a graphical representation of maximum tritium burn efficiency (TBE) for power multiplier p_{Δ}=0.95 versus core tritium fraction

$${f}_{T}^{c o}$$

and relative helium pumping speed with cross-section multiplier value NA_{J}=1.50.

FIG. 14D shows a graphical representation of maximum tritium burn efficiency (TBE) for power multiplier p_{Δ}=0.95 versus core tritium fraction

$${f}_{T}^{c o}$$

and relative helium pumping speed with cross-section multiplier value NA_{J}=1.90.

FIG. 15A shows a graphical representation of minimum required helium-to-hydrogen pumping speed Σ versus power multiplier p_{Δ} and TBE will cross-section multiplier value NA_{J}=1.00.

FIG. 15B shows a graphical representation of minimum required helium-to-hydrogen pumping speed Σ versus power multiplier p_{Δ} and TBE will cross-section multiplier value NA_{J}=1.25.

FIG. 15C shows a graphical representation of minimum required helium-to-hydrogen pumping speed Σ versus power multiplier p_{Δ} and TBE will cross-section multiplier value NA_{J}=1.50.

FIG. 15D shows a graphical representation of minimum required helium-to-hydrogen pumping speed Σ versus power multiplier p_{Δ} and TBE will cross-section multiplier value NA_{J}=1.90.

FIG. 16A shows a graphical representation of the required nₑτ_{E} multiplication factor C to maintain a fixed plasma gain versus TBE.

FIG. 16B shows a graphical representation of the required nₑ τ_{E} multiplication factor C to maintain a fixed plasma gain versus TBE and [symbol] A_{J}.

FIG. 16C shows a graphical representation of the required nₑτ_{E} multiplication factor C to maintain a fixed plasma gain versus

$${F}_{T}^{i n}$$

### and NAⱼ.

FIG. 17A shows a graphical representation of minimum fusion gain multiplier (versus p_{Δ} and TBE for NA_{J}=1.00.

FIG. 17B shows a graphical representation of minimum fusion gain multiplier (versus p_{Δ} and TBE for NA_{J}=1.25.

FIG. 17C shows a graphical representation of minimum fusion gain multiplier (versus p_{Δ} and TBE for NA_{J}=1.50.

FIG. 17D shows a graphical representation of minimum fusion gain multiplier (versus p_{Δ} and TBE for NA_{J}=1.90.

FIG. 18A shows a graphical representation of minimum tritium startup inventory I_{startup,min} as a function of tritium burn efficiency (TBE) and NA_{J}.

FIG. 18B shows a graphical representation of minimum tritium startup inventory I_{startup,min} as a function of tritium injection flow rate fraction

$${F}_{T}^{i n}$$

### and JV Aⱼ.

FIG. 19 is a graphical representation of tritium self-sufficiency and fusion power parameters of an ARC-like device for four cases with four TBE values and fixed spin polarization NA_{J}=1.5.

FIG. 20A shows a graphical representation of plasma gain [symbol] versus tritium burn efficiency (TBE) and spin-polarization multiplier NAⱼ for an ARC-like fusion power plant.

FIG. 20B shows a graphical representation of fusion power p_{f} versus tritium burn efficiency (TBE) and spin-polarization multiplier NAⱼ for an ARC-like fusion power plant.

FIG. 21A shows a graphical representation of the effect of [symbol] T_{α} [symbol] /T=2 on plasma gain Q versus tritium burn efficiency (TBE) and spin-polarization multiplier (NA_{J}) for a power plant with nominal Q=40.

FIG. 21B shows a graphical representation of the effect of [symbol] T_{α} [symbol] /T=5 on plasma gain Q versus tritium burn efficiency (TBE) and spin-polarization multiplier (NA_{J}) for a power plant with nominal Q=40.

FIG. 21C shows a graphical representation of the effect of [symbol] T_{α} [symbol] /T=10 on plasma gain Q versus tritium burn efficiency (TBE) and spin-polarization multiplier ( [symbol] A_{J}) for a power plant with nominal Q=40.

FIG. 22A shows a graphical representation of Y=(τ*_{He})(15T/E) versus tritium burn efficiency (TBE) for power degradation factor p_{Δ}=0.80.

FIG. 22B shows a graphical representation of Y=(τ*_{He})(15T/E) versus tritium burn efficiency (TBE) for power degradation factor p_{Δ}=0.95.

FIG. 22C shows a graphical representation of Y=(τ*_{He})(15T/E) versus tritium burn efficiency (TBE) for power enhancement factor p_{Δ}=1.05.

FIG. 22D shows a graphical representation of Y=(τ*_{He})(15T/E) versus tritium burn efficiency (TBE) for power enhancement factor p_{Δ}=1.30.

FIG. 23A shows a graphical representation of Y=(τ*_{He})(15T/E) versus tritium burn efficiency for power helium-to-hydrogen pumping ratio Σ=0.1 at fixed power degradation factor p_{Δ}=0.95.

FIG. 23B shows a graphical representation of Y=(τ*_{He})(15T/E) versus tritium burn efficiency for power helium-to-hydrogen pumping ratio Σ=0.5 at fixed power degradation factor p_{Δ}=0.95.

FIG. 23C shows a graphical representation of Y=(τ*_{He})(15T/E) versus tritium burn efficiency for power helium-to-hydrogen pumping ratio Σ=2.0 at fixed power degradation factor p_{Δ}=0.95.

FIG. 23D shows a graphical representation of Y=(τ*_{He})(15T/E) versus tritium burn efficiency for power helium-to-hydrogen pumping ratio Σ=10.0 at fixed power degradation factor p_{Δ}=0.95.

FIG. 24 shows a graphical representation of Y=(τ*_{He})(15T/E) versus tritium burn efficiency (TBE) for power degradation factor p_{Δ}=0.80.

FIG. 25A shows a graphical representation of tritium burn efficiency (TBE) versus tritium core fraction

$${\tilde{f}}_{T}^{c o}$$

for different spin-polarization multipliers [symbol] A_{J} and Ση_{He} values.

FIG. 25B shows a graphical representation of helium divertor fraction ƒ_{He,div} versus tritium core fraction

$${\tilde{f}}_{T}^{c o}$$

for different spin-polarization multipliers [symbol] A_{J} and Ση_{He} values.

FIG. 26A shows a graphical representation of plasma gain Q versus tritium burn efficiency (TBE) and spin polarization multiplier ( [symbol] A_{J}) for a SPARC-like fusion power plant with nominal Q=10.

FIG. 26B shows a graphical representation of plasma gain Q versus tritium burn efficiency (TBE) and spin polarization multiplier ( [symbol] A_{J}) for a SPARC-like fusion power plant with nominal Q=40.

FIG. 27 depicts a high-level block diagram of a computing device suitable for use within the context of the various embodiments.

FIG. 28 shows a schematic illustration of a system.

FIG. 29 shows a table of key fusion power and tritium self-sufficiency parameters for different operating scenarios in an ARC-like device.

It should be understood that the appended drawings are not necessarily to scale, presenting a somewhat simplified representation of various features illustrative of the basic principles of the present disclosure. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the present disclosure. It will thus be appreciated that those skilled in the art will be able to devise various arrangements that, although not explicitly described or shown herein, embody the principles of the present disclosure and are included within its scope. Furthermore, all examples recited herein are principally intended expressly to be only for illustrative purposes to aid the reader in understanding the principles of the present disclosure and the concepts contributed by the inventor(s) to furthering the art and are to be construed as being without limitation to such specifically recited examples and conditions. Additionally, the term, “or,” as used herein, refers to a nonexclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the claims. Moreover, some statements may apply to some features but not to others. Those skilled in the art and informed by the teachings herein will realize that the present disclosure is also applicable to various other technical areas or embodiments.

Tritium supply for future power plants is particularly challenging. D-T plants require a startup inventory because it takes time for tritium to be produced after the beginning of operations. During the time that on-site tritium production is ramping up to full capacity, the plant draws from a startup tritium inventory. The size of the tritium inventory can be considerable relative to global tritium supply. A ‘baseline’ ARC device design has a tritium startup inventory of ˜1 kg and a ‘baseline’ STEP device design has a tritium startup inventory of ˜9 kg. However, recent estimates have only ≈15 kg of theoretically available tritium for non-ITER fusion pilot plants after 2050, meaning that there could only be enough tritium to supply startup inventories for a handful of power plants. Fortunately, there are ways to significantly reduce the startup inventory requirement, with an increased TBE being found as by far the most important variable. Tritium modeling of an ARC-class device showed that increasing the TBE from 0.5% to 5% could decrease the startup tritium inventory by roughly a factor of ten. In addition to reducing the startup tritium inventory, a higher TBE also reduces the total circulating tritium inventory.

While increasing the TBE is beneficial for tritium self-sufficiency, it also is deleterious for plant economics because the fusion power is significantly lower. One potential solution to reduce the tradeoff between fusion power and TBE is to increase the ratio of helium to hydrogen divertor pumping efficiency 2, which could significantly increase the TBE (reducing the tritium startup inventory requirement) with a much smaller reduction in fusion power.

It has been suggested that the TBE can also be increased by decreasing the tritium fraction at fixed total hydrogen density. However, it was also noted that decreasing the tritium fraction also decreased the fusion power density, indicating a tradeoff between fusion power and TBE. Due to this fusion power decrease, it is likely economically prohibitive to operate with unpolarized D-T fuel at lower tritium fraction (and therefore high TBE) without significant progress in fusion science and technology.

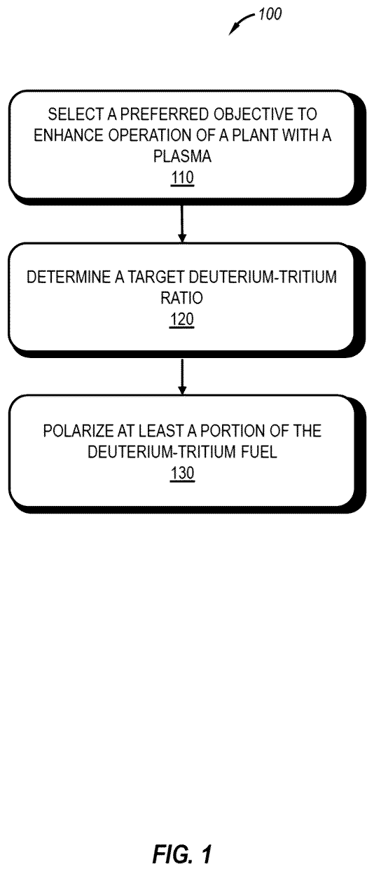

Referring now to FIG. 1, in various aspects, a method for optimizing the operation of a fusion plant (100) is shown. The method may include selecting (110) a preferred objective. The preferred objective may be chosen to enhance the operation of a plant with a plasma comprised of a deuterium-tritium fuel. The method may also include determining (120) a target deuterium-tritium ratio based on the preferred objective. The method may also include polarizing (130) at least a portion of the deuterium-tritium fuel according to the preferred objective before the deuterium-tritium fuel is injected into a fusion plasma.

In some embodiments, the preferred objective may be one of tritium burn efficiency, fusion power density, minimum tritium startup inventory, or desired power output, or a combination thereof. The preferred objective may include tritium fuel injection fraction and/or spin polarization. The preferred objective may be minimum tritium startup inventory. The minimum tritium startup inventory may be between about 10⁻³ kg to about 100 kg. The minimum tritium startup inventory may be between about 0.01 kg to about 50 kg. The minimum tritium startup inventory may be between about 0.01 kg to about 30 kg. The minimum tritium startup inventory may be between about 0.01 kg to about 25 kg. The minimum tritium startup inventory may be between about 0.01 kg to about 1 kg. The minimum tritium startup inventory may be between about 0.01 kg and 0.9 kg. The minimum tritium startup inventory may be between about 0.02 kg and 0.08 kg. The minimum tritium startup inventory may be between about 0.03 kg and 0.07 kg. The minimum tritium startup inventory may be between about 0.04 kg and 0.06 kg.

In some embodiments, the tritium burn efficiency may be between about 1%-60%. In a preferred embodiment, the tritium burn efficiency may be between about 10% to 50%. In a more preferred embodiment, the tritium burn efficiency may be between about 10% and 40%.

In some embodiments, the target deuterium-tritium ratio may be between about 51%-90% by number deuterium to 10%-49% by number tritium. In some embodiments, the target deuterium-tritium ratio may be between about 55%-80% by number deuterium to 20%-45% by number tritium. In some embodiments, the target deuterium-tritium ratio may be between about 55%-75% by number deuterium to 25%-45% by number tritium. In some embodiments, the target deuterium-tritium ratio may be between about 55%-70% by number deuterium to 30%-45% by number tritium. In some embodiments, the target deuterium-tritium ratio may be between about 55%-65% by number deuterium to 35-45% by number tritium. In some embodiments, the target deuterium-tritium ratio may be between about 57%-63% by number deuterium to 37%-43% by number tritium. In some embodiments, the target deuterium-tritium ratio may be about 57% by number deuterium and 43% by number tritium. In some embodiments, the target deuterium-tritium ratio may be about 61% by number deuterium and 39% by number tritium.

In some embodiments, nuclei of at least some deuterium and/or tritium may be polarized. In some embodiments, at least a tenth of the deuterium-tritium fuel may be polarized. In some embodiments, at least a quarter of the deuterium-tritium fuel may be polarized. In some embodiments, at least a third of the deuterium-tritium fuel may be polarized. In some embodiments, at least one half of the deuterium-tritium fuel may be polarized. In some embodiments, at least two-thirds of the deuterium-tritium fuel may be polarized. In some embodiments, at least three-fourths of the deuterium-tritium fuel may be polarized. In some embodiments, at least 95% of the deuterium-tritium fuel may be polarized.

In various aspects, a fusion fuel made by the method described herein may be provided.

In various aspects, a system may be provided. The system may include a non-transitory computer-readable medium carrying instructions to be executed by at least one processors. The instructions may be configured to perform a method for optimizing a fusion power plant. The instructions may be configured to receive a preferred optimization objective. The instructions may be configured to improve a deuterium-tritium fuel fraction according to the preferred optimization objective. Improving the deuterium-tritium fuel may include determining a deuterium-tritium fueling mix. Improving the deuterium-tritium fuel may include determining target spin polarizations for injected deuterium fuel and for injected tritium fuel.

In some embodiments, the preferred optimization objective may be at least one of tritium burn efficiency, fusion power density, and minimum startup inventory. The preferred optimization objective may be one of tritium fuel injection or spin polarization.

In some embodiments, the system may further include means for adjusting spin polarization of the deuterium-tritium fuel to achieve the preferred optimization objective.

The following description serves to illustrate the principles of the present disclosure. The description is provided to aid the reader in understanding the various techniques outlined herein. Also, the following description includes mathematical and experimental evidence of the various techniques outlined herein. Those skilled in the art and informed by the teachings herein will realize some statements may apply to some features but not to others.

It's demonstrated herein that using spin-polarized deuterium-tritium (D-T) fuel with more deuterium than tritium can increase tritium burn efficiency (TBE) by at least an order of magnitude without compromising fusion power output, compared to unpolarized fuel. Although previous studies show that a low tritium fraction can enhance TBE, these strategies resulted in reduced fusion power density. The surprising improvement in TBE at fixed power reported here is due to the TBE increasing nonlinearly with decreasing tritium fraction but the fusion power density increasing roughly linearly with D-T cross section. A study is performed for an ARC-like tokamak producing 481 MW of fusion power with unpolarized 53:47 D-T fuel, finding the minimum startup tritium inventory (I_{startup,min}) is 0.69 kg. By spin-polarizing half of the fuel and using a 60:40 D-T mix, I_{startup,min} is reduced to 0.08 kg, and fully spin-polarizing the fuel with a 63:37 D-T mix further reduced I_{startup,min} to 0.03 kg. Some ARC-like scenarios are predicted to achieve plasma ignition with relatively modest spin polarization. These findings indicate that, with advancements in helium divertor pumping efficiency, TBE values of approximately 10%-40% could be achieved using low-tritium-fraction and spin-polarized fuel with minimal power loss. This would dramatically lower tritium startup inventory requirements and reduce the amount of on-site tritium. More generally than just for spin-polarized fuels, increased plasma performance can be used to increase TBE. This strongly motivates the development of spin-polarized fuels and low-tritium-fraction operation for burning plasmas.

An example of a plant operating with a reduced tritium fraction and spin-polarized (SP) fuel that achieves a 15 times greater TBE than a plant operating with 50:50 D-T and unpolarized fuel, without any degradation in fusion power is shown herein. A significant result of this approach is that the initial tritium inventory requirements might be reduced by an order of magnitude to levels that shortages of tritium supply could be eliminated. More speculatively, a power plant operating with SP fuel and higher TBE might also achieve a higher TBR because of anisotropic fusion neutron emission, which could allow for blanket thickness and material optimization according to the neutron flux's spatial distribution. Additionally, the required TBR for tritium self-sufficiency could decrease because of reduced tritium flows throughout the plant, decreasing tritium losses. This would allow plants to breed tritium more quickly, increasing the global tritium inventory. A power plant designed to operate at a range of tritium fractions would provide operating flexibility and might stabilize tritium prices: if the marginal profit of additional electricity generation is higher than selling additional tritium, the plant could change its configuration to breed less tritium and generate more fusion power and electricity. It would almost always be desirable to operate at higher polarization fraction.

While it is well known that polarizing deuterium and tritium nuclear spins increases the cross section by up to 50%, SP fuels have not yet been tested in fusion plasmas. However, the first SP fusion experiments to test the polarization lifetime are planned for 2025 on the DIII-D tokamak using deuterium helium-3 fuel. Recent advances have now made it possible to polarize deuterium and helium-3 gas to ˜60%-70%, to produce SP fuel at sufficiently large quantities for experiments, and to keep the fuel polarized during the injection process. Due to nonlinear effects in the plasma, the total fusion power increase with SP fuels can be even higher than the 50% cross-section enhancement, reportedly 80% and 90%. Such benefits would dramatically improve the economics of fusion power plants. However, there are major obstacles to overcome before SP fuels could be used to fuel power plants. Ensuring that fuel remains polarized sufficiently long is particularly challenging, with ion-cyclotron frequency resonances and metallic-wall interactions in high recycling regimes particularly worrisome. Additionally, it is technologically hard to simultaneously achieve a high polarization fraction and produce sufficient fuel in a power plant fueling scheme, although there are recent promising advances.

The core insight of the present disclosure is as follows: while tritium self-sufficiency challenges such as supply shortages for startup inventory are concerning, many of these challenges directly result from insufficient fusion plasma performance. If fusion power density can be improved through plasma physics advances, it can then be exchanged for higher tritium burn efficiency. The result is a comparable or even high total fusion power with tritium burn efficiency at least an order of magnitude higher. Spin-polarized fusion (→higher power density) with lower tritium fraction (→higher TBE), which is studied in this present disclosure, is just one example of increasing the fusion plasma performance.

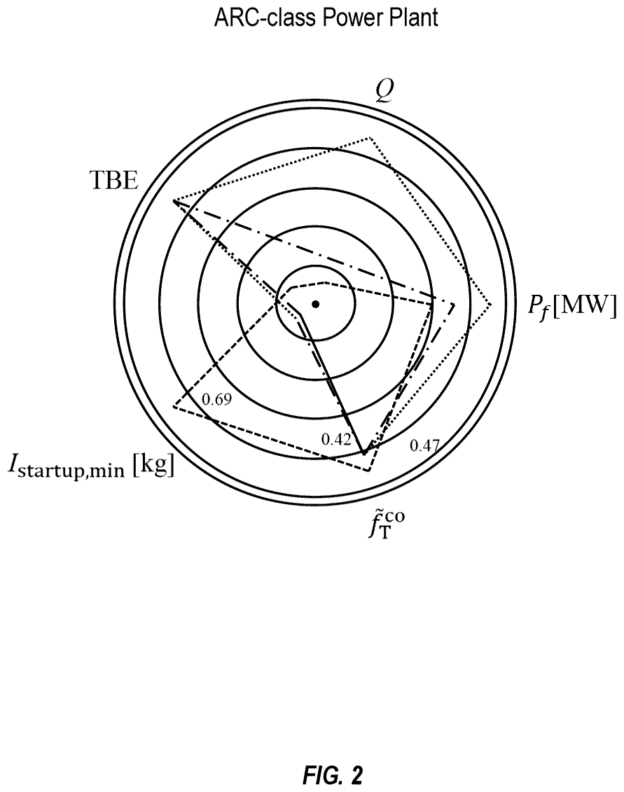

As a quick summary, the main results are shown in FIG. 2, which illustrates a spider plot comparing performance parameters of an ARC-class power plant. The plot has five axes: plasma gain Q, fusion power p_{f}, typical core tritium fraction

$${f}_{T}^{co} ,$$

minimum tritium startup inventory I_{startup,min}, and the TBE. Each line corresponds to an effective cross-section enhancement NA_{J} due to spin polarization. [symbol] A_{J}=1.0 is for unpolarized fuel and NA_{J}=1.9 represents the 90% enhancement found in other studies. FIG. 2 shows results for the following line of inquiry: for an ARC-like power plant, what is the effect of specifying three different spin-polarization values NA_{J} and requiring a given TBE? The outputs are Q, p_{f}, I_{startup,min}, and

$${f}_{T}^{co} .$$

with a 50% effective cross-section enhancement due to spin polarization requiring TBE=0.10, plasma [symbol] increases 20% from 19.1 to 38.4, fusion power increases 17% from 481 MW to 563 MW, and the tritium startup inventory decreases 89% from 0.69 kg to 0.08 kg. To accomplish this, the typical core tritium density fraction

$${f}_{T}^{co}$$

must decrease from 4770 10 42%. If one could achieve even higher effective cross section multiplier NA_{J}=1.9, for TBE 0.10, the plasma ignites and the fusion power increases to p_{f}=714MW. More details of these and other cases are provided herein.

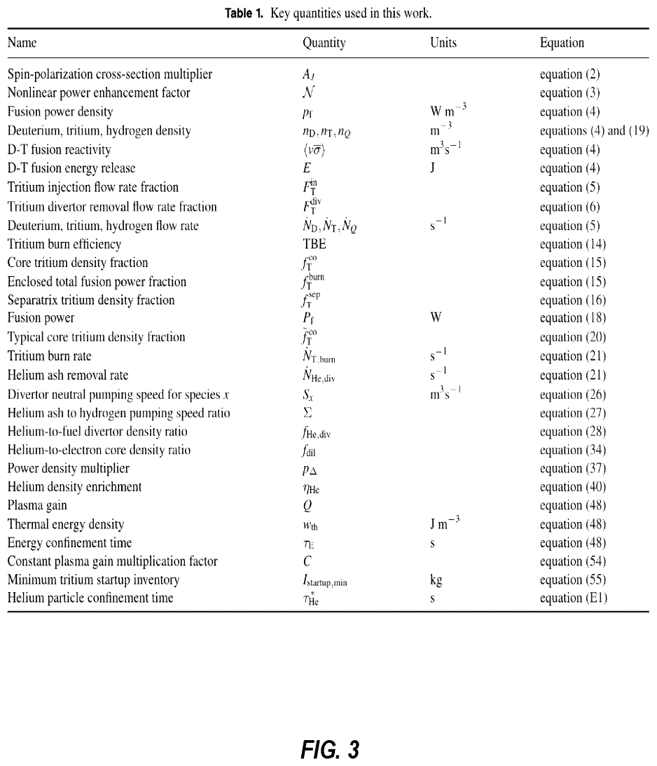

The main parameters that are used in this work are listed in FIG. 3.

### Spin Polarization

In this section, the fuel polarization is introduced. The total D-T fusion cross section is

$$σ = \overline{σ} {A}_{J} \qquad ( 1 )$$

Where σ̅ is the nominal unpolarized D-T cross section and A_{J} is the polarization cross-section multiplier

$${A}_{J} ≡ ( 1 + {P}_{D} {P}_{T} / 2 ) \qquad ( 2 )$$

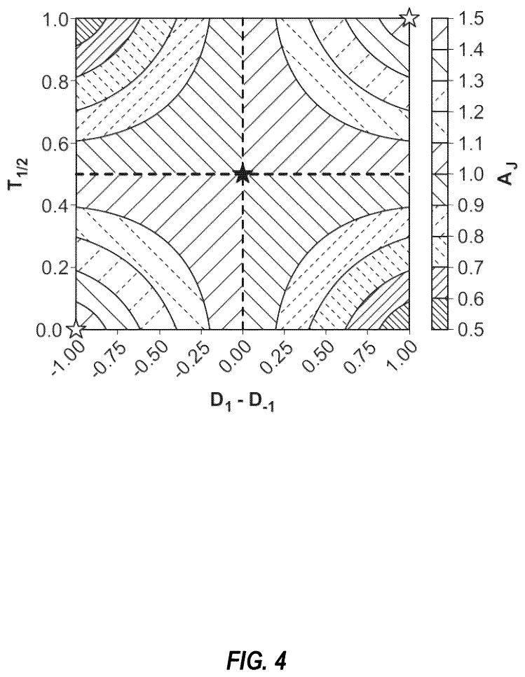

Which generally satisfies Aⱼ ∈ [0.5,1.5], For unpolarized fusion, the nuclear spins are randomly oriented and Aⱼ=1.0. Here p_{D}, p_{T} are vector polarizations of deuterium and tritium, where p_{D}=D₁-D₋₁ and p_{T}=T_{1/2}-T_{-½}. Here, Dₘ and Tₘ are the probabilities of being in a nuclear spin state m, where m=1, 0,−1 for deuterium and m=½,−½ for tritium, satisfying ΣDₘ=σTₘ=1. By choosing p_{D}p_{T}=1, the cross-section is enhanced by 50%. This is referred to as the enhanced parallel polarization' (EPP) scheme. The EPP scheme is indicated with [[FILL IN]] in FIG. 4 and an unpolarized fuel with [FILL IN]]. Shown in FIG. 4, both tritium and deuterium must have some polarization bias for the multiplier A_{J} to change from 1. While polarizing just one of deuterium or tritium does not change the total cross section it does change the differential cross section.

It is important to note that the fusion power increase has been reported to be higher than the cross-section increase for SP fuel. Recent works have found that with A_{J}=1.5, the total fusion power increased by 80% and 90% (higher than 50% from the increased cross section) due to increased alpha heating. To approximately capture this nonlinear effect in this work, the temperature-dependent D-T fusion reactivity [symbol] νσ̅ [symbol] is pre-multiplied by a nonlinear-enhancement factor [symbol] ,

$$〈 v \overline{σ} 〉 \to 𝒩 〈 v \overline{σ} 〉 \qquad ( 3 )$$

Physically, N results from modifications to the temperature and (possibly) density due to alpha heating. The fusion power density on a flux surface is

$${p}_{f} = 𝒩 {A}_{J} {n}_{D} {n}_{T} 〈 v \overline{σ} 〉 E \qquad ( 4 )$$

Where n_{D} and n_{T} are the deuterium and tritium densities, and E=17.6 MeV is the energy released from the D-T fusion reaction. For power increases of 80% and 90% with Aⱼ=1.5, one would set NA_{J}=1.8, 19. When NA_{J}=1, equation (4) return to the standard expression for fusion power density, p_{f}= [symbol] E. Throughout the present disclosure N and A_{J} will always appear together as NA_{J}. Additionally, [symbol] νσ̅ [symbol] should be interpreted as being at constant temperature for N≠1; all of the temperature dependence is carried by N. For further discussion of the limitations of and potential solutions to this approach, See appendix D.1.

### Variable Tritium Fraction

In this section, the notation for D-T plasmas with a variable tritium fraction are introduced. The analysis is confined to steady-state operation in magnetic confinement fusion power plants such as tokamaks, stellarators, and mirrors.

Plasmas are studied where the particle densities and flow rates are not necessarily equal for deuterium and tritium. A power plant operator controls the tritium fraction

$${F}_{T}^{in}$$

of the total fuel injection rate

$${F}_{T}^{in} ≡ \frac{{\dot{N}}_{T , in}}{{\dot{N}}_{Q , in}} \qquad ( 5 )$$

Where \dot{N}_{T,in} and \dot{N}_{Q,in} are the number of tritium and total unburned fuel particles injected into the device chamber per second. In the divertor, the tritium fraction

$${F}_{T}^{div}$$

of the total unburned fuel removal rate is

$${F}_{T}^{in} ≡ \frac{{\dot{N}}_{T , div}}{{\dot{N}}_{Q , div}} \qquad ( 6 )$$

Where \dot{N}_{T,div} and \dot{N}_{Q,div} are the total number of tritium and total unburned fuel particles injected into the device chamber per second. It's assumed that the D-T core density mix is 1:α where α≥0 is a real number. The tritium and deuterium core densities satisfy

$${n}_{T , co} = {an}_{D , co} , {n}_{T , co} + {n}_{D , co} = ( 1 + a ) {n}_{D , co} \qquad ( 7 )$$

Practically, a D-T mix that is not 1:1 is maintained by differing injection and divertor removal rates for deuterium and tritium. In appendix A, its shown that the core tritium flow rate fraction on a flux surface

$${F}_{T}^{co} ≡ \frac{{\dot{N}}_{T , co}}{{\dot{N}}_{Q , co}} \qquad ( 8 )$$

Is equal to the tritium density fraction

$${f}_{T}^{co}$$

under certain assumptions. Here, \dot{N}_{Q,co} and \dot{N}_{Q,co} are the number of tritium and total unburned fuel particles passing radially outwards through a flux surface per second. For this work, it's assumed that

$${f}_{T}^{co} = {F}_{T}^{co} \qquad ( 9 )$$

Where

$${f}_{T}^{co} ≡ \frac{{n}_{T , co}}{{n}_{Q , co}} \qquad ( 10 )$$

\dot{N}_{T,co} is defined as the tritium flow rate through a flux surface hat encloses a fraction ƒ_{burn} of the total fusion power,

$${\dot{N}}_{T}^{co} ≡ {\dot{N}}_{T}^{in} - {f}_{burn} {\dot{N}}_{T}^{burn} \qquad ( 11 )$$

Where

$${\dot{N}}_{Q}^{co}$$

also satisfies

$${\dot{N}}_{T}^{co} = {\dot{N}}_{Q}^{in} - 2 {f}_{burn} {\dot{N}}_{T}^{burn} \qquad ( 12 )$$

Equations (11) and (12) are derived in appendix B. Here,

$${\dot{N}}_{T}^{burn}$$

is the tritium burn rate within the plasma/ By introducing the radial coordinate ƒ_{burn}, a radial dependence has been introduced to

$${F}_{T}^{co} and {f}_{T}^{co} :$$

at the magnetic axis ƒ_{burn}=0 and at the separatrix ƒ_{burn}=1.0. Equation (11) and (12) describe a model where all of the deuterium and tritium fuel is injected on the magnetic axis. Other particle sources are ignored such as wall fueling.

Dividing equation (11) by equation (12) gives

$${F}_{T}^{co} = \frac{{F}_{T}^{in}}{1 - 2 {f}_{burn} {F}_{T}^{in} TBE} ( 1 - {f}_{burn} TBE ) \qquad ( 13 )$$

And therefore

$${F}_{T}^{co}$$

is a flux fraction. The tritium burn efficiency (TBE) is defined as

$$TBE = \frac{{\dot{N}}_{T}^{burn}}{{\dot{N}}_{T}^{in}} = {( \frac{{\dot{N}}_{T , div}}{{\dot{N}}_{He , div}} + 1 )}^{- 1} \qquad ( 14 )$$

Which measures the probability of a tritium particle undergoing a fusion reaction from the moment it is injected into the chamber to the moment it leaves the chamber through the divertor. Here,

$${\dot{N}}_{He}^{div}$$

is the helium ash removal rate. Note that the TBE is different to the more frequently used burn fraction, which measures the fraction of tritium burned in a single pass through the plasma. Equating equations (A10) and (13),

$${f}_{T}^{co}$$

is

$${f}_{T}^{co} = \frac{{f}_{burn} TBE - 1}{2 {f}_{burn} TBE - 1 / {F}_{T}^{in}} \qquad ( 15 )$$

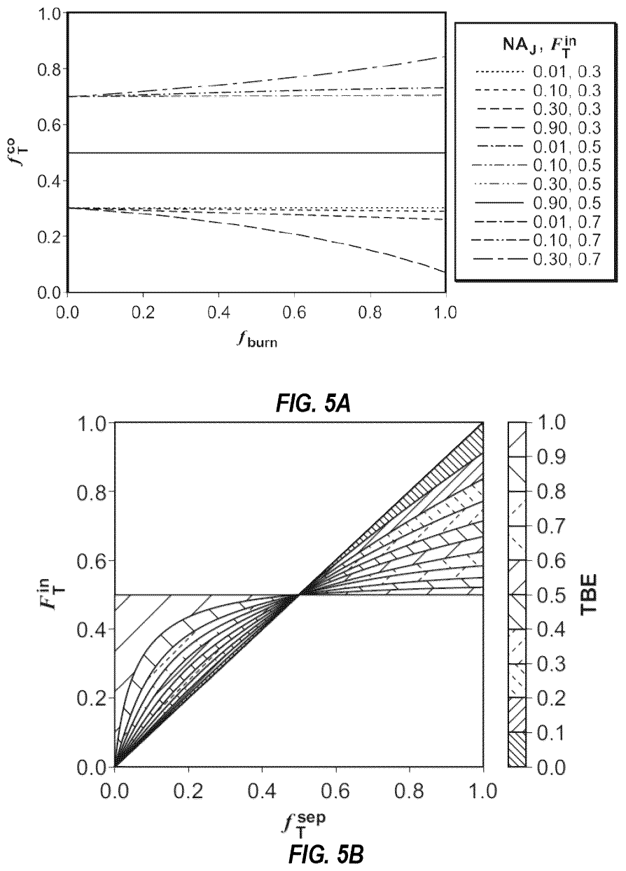

The solutions to this equation is plotted in FIG. 5A, showing how the tritium core fraction decreases with increasing TBE, and decreasing

$${F}_{T}^{in} .$$

Defining the tritium density fraction at the separatrix,

$${f}_{T}^{sep} ≡ {f}_{T}^{co} ( {f}_{burn} = 1 ) , \qquad ( 16 )$$

And rearranging equation (15) with ƒ_{burn}=1 for the TBE, it's found that

$$TBE = \frac{1 - {f}_{T}^{sep} / {F}_{T}^{in}}{1 - 2 {f}_{T}^{sep}} . \qquad ( 17 )$$

Solutions to the TBE in equation (17) are shown in FIG. 5B. Both

$${f}_{T}^{sep} and {F}_{T}^{in}$$

must have values less than ½ or greater than ½. Generally, much higher TBE values are accessible for

$${f}_{T}^{sep}$$

values closer to 0 (representing a very high tritium burnup) and

$${F}_{T}^{in}$$

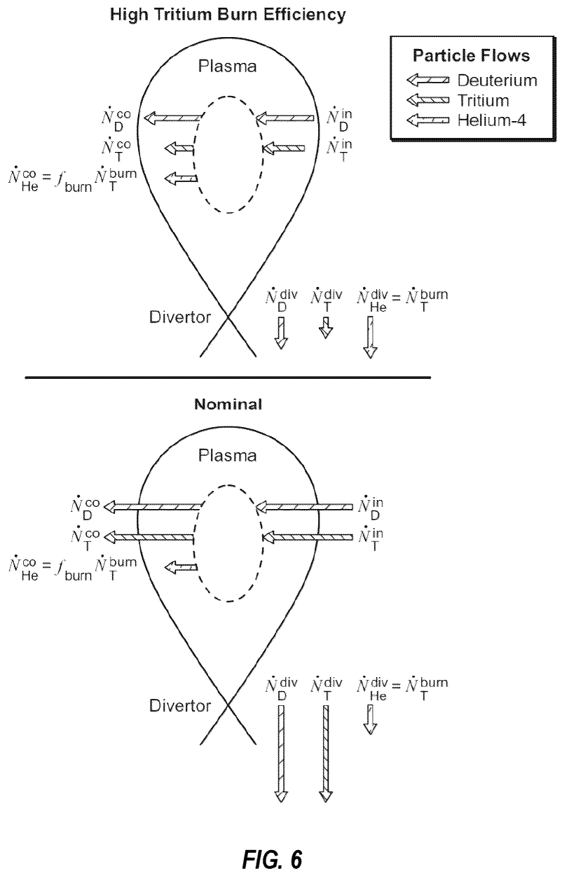

closer to ½. The tritium, deuterium, and helium flows are shown schematically in FIG. 6.

### Spin-Polarized Fuel

In this section, the effects of spin polarization on the fusion power, tritium burn efficiency, and fusion gain are studied.

The total fusion power p_{f} is

$${P}_{f} ≡ \int {p}_{f} dV = E {\dot{N}}_{α} \qquad ( 18 )$$

Where the integral is evaluated over the total plasma volume V and \dot{N}_{α} is the alpha production rate in the whole plasma. The typical power density on a flux surface p_{f} is

$${p}_{f} = {\tilde{f}}_{T}^{co} ( 1 - {\tilde{f}}_{T}^{co} ) 𝒩 {A}_{J} {n}_{Q , co}^{2} 〈 v \overline{σ} 〉 E \qquad ( 19 )$$

Where n_{Q,co}=N_{D,co}+N_{T,co} is the unburned fuel density and it's defined that

$${\tilde{f}}_{T}^{co} ≡ {f}_{T}^{co} ( {f}_{burn} ≡ 1 / 2 ) , \qquad ( 20 )$$

Such that

$${\tilde{f}}_{T}^{co}$$

describes the flux surface enclosing half of the power fusion power at ƒ_{burn}=½.

By particle conservation, the alpha production rate is equal to the tritium rate \dot{N}_{T,burn} and the helium ash removal in the divertor \dot{N}_{He,div},

$${\dot{N}}_{α} = {\dot{N}}_{T , burn} = {\dot{N}}_{He , div} . \qquad ( 21 )$$

Conservation of particles requires that

$${\dot{N}}_{Q , in} = 2 {\dot{N}}_{He , div} + {\dot{N}}_{Q , div} . \qquad ( 22 )$$

Using equations (21) and (22) and (6) becomes

$${\dot{N}}_{T , div} = {F}_{T}^{div} ( \frac{{\dot{N}}_{T , in}}{{F}_{T}^{in}} - 2 {\dot{N}}_{α} ) . \qquad ( 23 )$$

Equation (23) shows that the tritium divertor flow rate is proportional to the difference between injected hydrogen and alpha particle production. The individual tritium and deuterium flow rates satisfy

$${\dot{N}}_{T , in} = {\dot{N}}_{T , div} + {\dot{N}}_{He , div} = \frac{{F}_{T}^{in}}{1 - {F}_{T}^{in}} {\dot{N}}_{D , in} . \qquad ( 24 )$$

Some of the contributions of the present disclosure include the effects of the spin-polarization multiplier [symbol] Aⱼ and tritium injection fraction

$${F}_{T}^{in} .$$

A fusin power plant operator could control Aⱼ and

$${F}_{T}^{in}$$

(but not necessary [symbol] ) with a fueling scheme where the polarization and tritium fraction are adjustable.

Substituting

$$\dot{{N}_{T , div}} = {F}_{T}^{div} {\dot{N}}_{Q , div}$$

(see equation (6)) into equation (14) gives

$$TBE = {( {F}_{T}^{div} \frac{{\dot{N}}_{Q , div}}{{\dot{N}}_{He , div}} + 1 )}^{- 1} \qquad ( 25 )$$

It is wished to replace \dot{N}_{Q,div} and \dot{N}_{He,div} by dimensionless variables. To do this, the divertor flow rate for a species x as given by the neutral gas density n_{x,div} and effective pumping speed Sₓ are written as

$${\dot{N}}_{x , d i v} = {n}_{x , div} {S}_{x} . \qquad ( 26 )$$

The helium-to-fuel divertor pumping ratio is

$$Σ ≡ \frac{{S}_{He}}{{S}_{Q}} . \qquad ( 27 )$$

And the helium-to-fuel divertor density ratio is

$${f}_{He , div} ≡ \frac{{n}_{He , div}}{{n}_{Q , div}} \qquad ( 28 )$$

Using equations (26)-(28) in equation (25) it's found that

$$\frac{{\dot{N}}_{He , div}}{{\dot{N}}_{Q , div}} = {f}_{He , div} Σ . \qquad ( 29 )$$

Therefore, substituting equation (29) into equation (25)

$$TBE = {( {F}_{T}^{d i v} \frac{1}{{f}_{H e , d i v} Σ} + 1 )}^{- 1} \qquad ( 30 )$$

From the perspective of a plant operator, the tritium injection fraction

$${F}_{T}^{i n}$$

is easier to control than

$${F}_{T}^{d i v} ,$$

and so the TBE is rewritten in terms of

$${F}_{T}^{i n} .$$

Using the expression for

$${F}_{T}^{d i v}$$

in equation (6) and \dot{N}_{Q,div} in equation (29), the TBE expressed in terms of

$${F}_{T}^{i n}$$

is

$$TBE = {( \frac{{F}_{T}^{i n}}{{f}_{H e , d i v} Σ ( 1 + {f}_{He , div} Σ ( \frac{1}{{F}_{T}^{i n}} - 2 ) )} + 1 )}^{- 1} \qquad ( 31 )$$

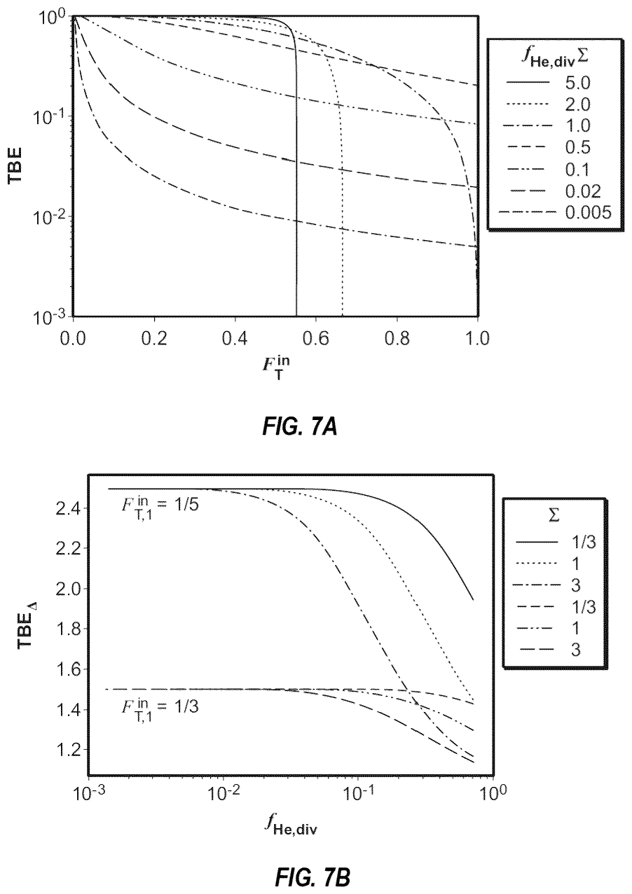

Which is plotted in FIG. 7A: decreasing

$${F}_{T}^{d i v}$$

at fixed ƒHe,div increases the TBE for

$${F}_{T}^{i n} < 1 / 2$$

but its effect is more complicated for

$${F}_{T}^{i n} > 1 / 2.$$

To measure the improvement in the TBE with lower

$${F}_{T}^{i n} ,$$

the TBE enhancement is defined as

$$T B {E}_{Δ} ( {F}_{T}^{i n} , {f}_{He , div} , Σ ) ≡ \frac{T B E ( {F}_{T}^{i n} , {f}_{He , div} , Σ )}{T B E ( {F}_{T}^{i n} = 1 / 2 , {f}_{\{ He , div , Σ )} \}} \qquad ( 32 )$$

Which measures the enhancement (or degradation) of the TBE relative to the TBE with an equal tritium and deuterium mix,

$${F}_{T}^{i n} = 1 / 2.$$

### In FIG. 7B TBE_{Δ} for

$${F}_{T}^{i n} = 1 / 5 , 1 / 3.$$

In the region

$${F}_{T}^{d i v} / {f}_{He , div} Σ ≫ 1 ,$$

$$T B {E}_{Δ} \approx \frac{1}{{F}_{T}^{div}} ≅ \frac{1}{{F}_{T}^{i n}} . \qquad ( 33 )$$

FIG. 7B shows that the relative improvement in the TBE scheme for a small tritium fraction is only significantly less than

$$1 / {F}_{T}^{i n}$$

when ƒ_{He,div}Σ is order unity, and even when ƒ_{He,div} is order unity, there is still a substantial improvement in the TBE.

It is important to note that all of the analysis up to this point does not assume that the fusion power is constant. The present disclosure next examines more physically relevant questions such as how the TBE depends on the tritium fraction and spin polarization at constant power and fusion gain.

The helium-to-electron core density ratio is

$${f}_{d i l} ≡ \frac{{n}_{α}}{{n}_{e}} . \qquad ( 34 )$$

Also known as the ash dilution fraction. Using quasineutrality

$${n}_{e} = {n}_{Q , c o} + 2 {n}_{α} , \qquad ( 35 )$$

And ignoring impurities, the fusion power density as a function of

$${\tilde{f}}_{T}^{c o} ,$$

ƒ_{dil}, and [symbol] A_{J} is

$${p}_{f} = 4 ( 1 - {\tilde{f}}_{T}^{c o} ) {( 1 - 2 {f}_{d i l} )}^{2 N} {A}_{J} {n}_{e}^{2} 〈 v \overline{σ} 〉 \frac{E}{4} , \qquad ( 36 )$$

Where nₑ is the electron density. Thus, at fixed nₑ and temperature, the fusion power density p_{f} relative to its maximum value p_{f,max}, where p_{f,max} has

$${\tilde{f}}_{T}^{c o} = 1 / 2 , {f}_{d i l} = 0 , {𝒩A}_{J} = 1 ,$$

is given by the power multiplier p_{Δ}

$${p}_{Δ} = \frac{{p}_{f}}{{p}_{f , max}} = 4 {\tilde{f}}_{T}^{c o} ( 1 - {\tilde{f}}_{T}^{c o} ) {( 1 - 2 {f}_{d i l} )}^{2} {𝒩A}_{J} , \qquad ( 37 )$$

Importantly, in Eq. (37) ƒ_{dil} cannot be varied independently of

$${\tilde{f}}_{T}^{c o}$$

and [symbol] A_{J}, and hence, at fixed [symbol] NA_{J} the power density p_{Δ} is not necessarily maximized for an equal D₋₁ mixture,

$${\tilde{f}}_{T}^{c o} = 1 / 2.$$

This is unlike other studies that used p_{Δ}=(1-2ƒ_{dil})² where it was assumed that

$${\tilde{f}}_{T}^{c o} = 1 / 2$$

and [symbol] A_{J}=1.0.

Using a simple estimate for p_{Δ}, it's first shown how a plasma with

$${f}_{T}^{c o} = 0.21$$

and spin polarization [symbol] A_{J}=1.5 has the same power as an unpolarized plasma with

$${f}_{T}^{c o} = 0 \text{.5} .$$

This simple estimate is obtained by neglecting helium dilution effects (setting ƒ_{dil}=0.0 in equation (37)). In FIG. 8, the power density enhancement factor

$${p}_{f} / {p}_{f} ( {\tilde{f}}_{T}^{c o} = 0.5 , {𝒩A}_{J} ) = 1.0$$

is plotted versus

$${\tilde{f}}_{T}^{c o}$$

and [symbol] A_{J}. The [GREY STAR]] indicates the unpolarized 50:50 D-T mix

$${p}_{f} ( {\tilde{f}}_{T}^{c o} = 0.5 , {𝒩A}_{J} = 1. )$$

### and the [YELLOW STAR] the EPP-enhanced 79:1 D-T mix

$${p}_{f} ( {\tilde{f}}_{T}^{c o} = 0.21 , {𝒩A}_{J} = 1.5 ) .$$

FIG. 8 demonstrates that with 100% core fuel polarization in the EPP scheme, at fixed temperature and n_{Q,co} the power density with

$${\tilde{f}}_{T}^{c o} = 0.21$$

is, equal to an unpolarized fuel with

$${\tilde{f}}_{T}^{co} = 0.5 .$$

### That is,

$${p}_{f} ( {\tilde{f}}_{T}^{co} = 0.21 , 𝒩 {A}_{J} = 1 \text{.5} ) = {p}_{f} ( {\tilde{f}}_{T}^{co} = 0 \text{.5} , 𝒩 {A}_{J} = 1.0 ) . \qquad ( 38 )$$

Equation (38) means that 58% less tritium (but 58% more deuterium) needs to be injected in the EPP scheme to match the power density of the unpolarized scheme. Using the highest value of [symbol] A_{J}=1.9 reported in the literature gives a 15% tritium fraction to match the unpolarized fuel power density,

$${p}_{f} ( {\tilde{f}}_{T}^{co} = 0.15 , 𝒩 {A}_{J} = 1 \text{.9} ) = {p}_{f} ( {\tilde{f}}_{T}^{co} = 0.5 , 𝒩 {A}_{J} = 1.0 ) . \qquad ( 39 )$$

Next p_{Δ} is studied including helium dilution effects.

Another important quantity is the helium enrichment, the ratio of the helium-to-fuel density ratios in the diverter and the core,

$${η}_{He} ≡ \frac{{f}_{He , div}}{{f}_{α , co}} \qquad ( 40 )$$

Where the helium-to-fuel density ratio in the core is

$${f}_{α , co} ≡ \frac{{n}_{α}}{{f}_{Q , co}} . \qquad ( 41 )$$

Combining equations (37) and (40) one obtains

$${p}_{Δ} = 4 {{\tilde{f}}_{T}^{co} ( 1 - {\tilde{f}}_{T}^{co} ) [ 1 - {( 1 + \frac{{η}_{He}}{2 {f}_{He , div}} )}^{- 1} ]}^{2} 𝒩 {A}_{J} , \qquad ( 42 )$$

Where the following is used

$${f}_{dil} = \frac{{f}_{He , div} / {η}_{He}}{1 + 2 {f}_{He , div} / {η}_{He}} . \qquad ( 43 )$$

Rearranging the TBE in equation (3) gives,

$${f}_{He , div} = \frac{{F}_{T}^{div}}{\sum ( \frac{1}{TBE} - 1 )} . \qquad ( 44 )$$

And substituting in equation (42) one finds

$${p}_{Δ} = 4 {\tilde{f}}_{T}^{co} ( 1 - {\tilde{f}}_{T}^{co} ) {( 1 - \frac{2 {f}_{T}^{sep}}{\sum {η}_{He} ( 1 - \frac{1}{TBE} )} )}^{- 2} 𝒩 {A}_{J} , \qquad ( 45 )$$

Where the separatrix-divertor boundary condition is imposed

$${f}_{T}^{sep} = {F}_{T}^{div} , \qquad ( 46 )$$

The following is a brief comment on the product Ση_{He}, which appears in equation (45). While p_{Δ} depends on the product Ση_{He}, other quantities in p_{Δ} such as the TBE do not have the same functional dependence on the product Ση_{He}. Therefore, it is important to note that Σ and η_{He} have distinct physical effects. One must be careful in interpreting equation (45), since not all variables are independent. A description on how to meaningfully interpret equation (45) is now provided. The following quantities are fixed inputs for the following calculations: Σ, η_{He}. For each [symbol] NA_{J} and TBE value, one calculates the maximum p_{Δ} over all possible

$${F}_{T}^{in}$$

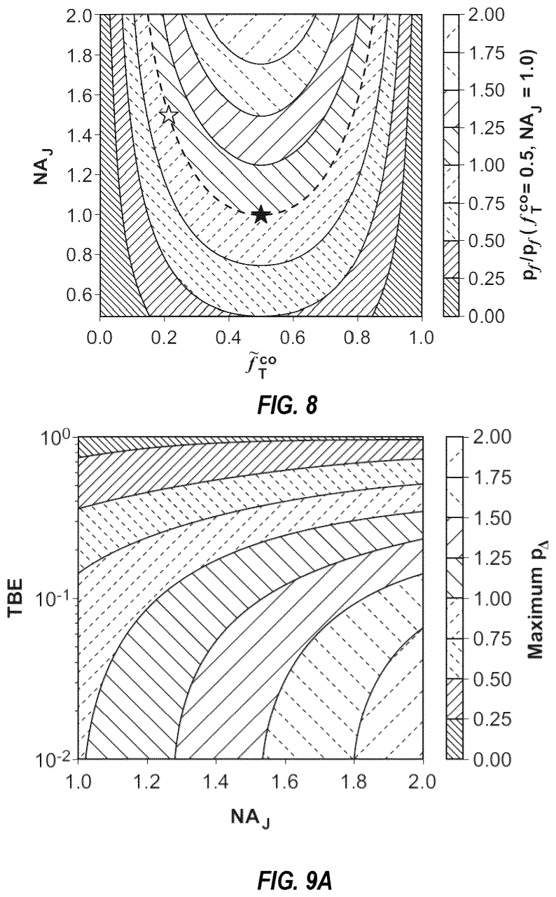

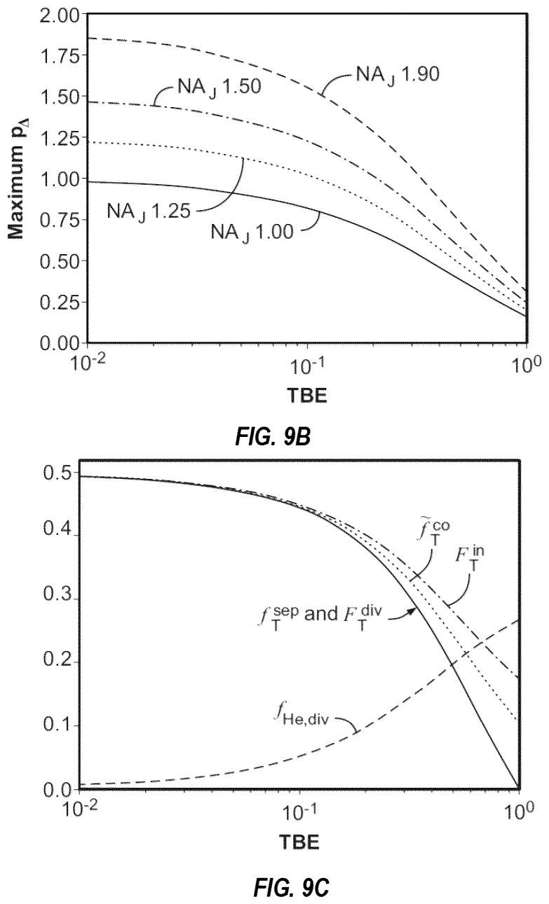

values, and the resulting maximum p_{Δ} is plotted in FIG. 9A. Notably, following a contour of constant p_{Δ} allows the TBE to increase by roughly an order of magnitude as NA_{J} increases. In FIG. 9B, one plots the maximum p_{Δ} versus TBE for four NA_{J} values, again showing how at fixed p_{α} the TBE increases dramatically with spin-polarization. For example, p_{Δ}=0.95 gives TBE≈0.01 for unpolarized fuel (NA_{J}=1.0), but TBE≈0.12 is achievable with modest polarization (NA_{J}=1.25) and TBE≈0.31 is achievable with strong polarization (NA_{J}=1.90). Therefore, in this example, polarizing the fuel from NA_{J}=1.0 to NA_{J}=1.9 increased the TBE by a factor of thirty without a power decrease. Notably, even small increases in polarization (NA_{J}=1.0 to NA_{J}=1.25) increased the TBE by an order of magnitude.

In FIG. 9C, the following is plotted:

$${f}_{T}^{sep} , {\tilde{f}}_{T}^{co} , {f}_{He , div} , {F}_{T}^{in} , and {F}_{T}^{div}$$

values that give the maximum p_{Δ}. These values are independent of [symbol] NAⱼ for our scan. As expected, as IBE→1,

$${f}_{T}^{sep} and {F}_{T}^{div} \to 0 .$$

Notably, the value of ƒ_{He,div} also becomes fairly large, showing how helium-4 replaces tritium in the divertor. The reader is now reminded that for these scans, Σ and η_{He} are held constant. Also of note is that when increasing TBE at constant Ση_{He} and [symbol] A, values, the maximum power enhancement p_{Δ} always occurs when

$${\tilde{f}}_{T}^{co} < 0.5 .$$

The maximum power enhancement occurring at

$${\tilde{f}}_{T}^{co} < 0.5$$

is valid when ƒ_{He,div} in equation (44) varies self-consistently with changes in

$${F}_{T}^{div} ,$$

and TBE (and η_{He} and Σ, which are held constant in this scan). The result that ushing a plasma close to its maximum achievable power gives poor TBE was also explained by others. In the present application, the idea is extended to spin-polarized fuel with the following analogy. Suppose one is a driver in an endurance car race. Because of the tradeoff between speed and efficiency, the winning strategy involves a careful balance between speed and fuel economy. Suppose that a new combustion fuel is discovered with a 50% higher reactivity. One could maintain the same top speed at much lower RPM, leading to big fuel savings, fewer pitstops, and less engine wear. Spin-polarized fuel shares some of these properties: at fixed fusion power (car speed) the tritium burn efficiency (fuel economy) increases substantially, leading to a lower tritium startup and circulating inventory (fuel level) and operating at a fusion power that is comfortably within the device's capabilities (manageable crankshaft revolutions per minute).

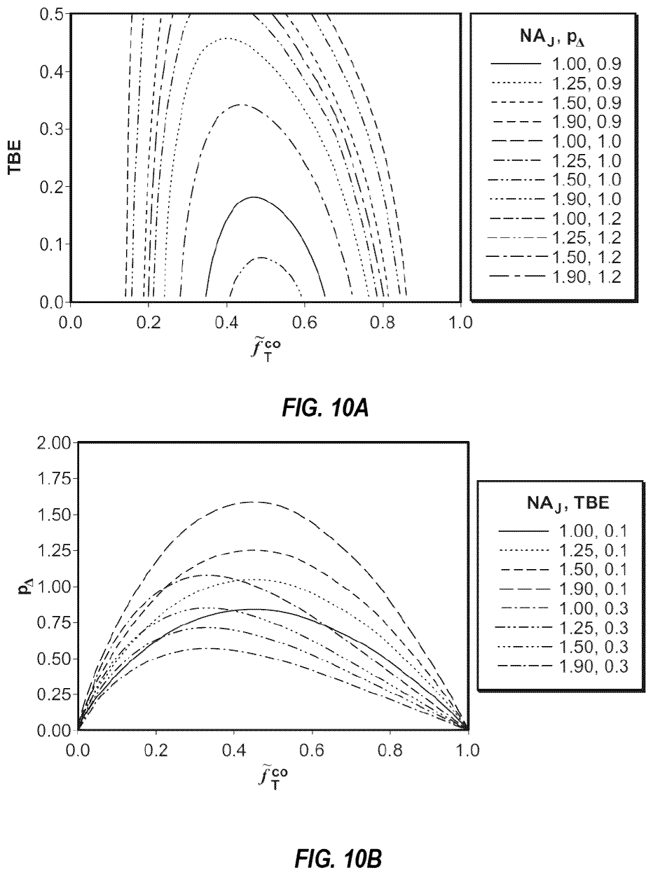

By choosing to operate a power plant with unpolarized fuel close to p_{Δ}=1.0, an unacceptably low TBE is forced, thereby placing high demands on the plant's tritium systems. However, it might also be economically very undesirable to operate at lower fusion power p_{Δ}≤0.8 where the TBE is higher. Spin-polarized fuels offer a way out of this conundrum: the higher cross section allows operation at lower tritium fraction and thus higher TBE, while maintaining the same power density as unpolarized fuels with a 50:50 D-T mix. This is summarized in FIG. 10A and FIG. 10B, where polarized fuel and lower

$${\tilde{f}}_{T}^{co}$$

values give an order of magnitude higher TBE than unpolarized fuel at the same power density. This is the major new insight of the present disclosure.

The very strong sensitivity of the TBE on small increases in polarization for p_{Δ} close to 1 results from a resonant denominator in the TBE of the form

$$\sqrt{4 {\tilde{f}}_{T}^{co} ( 1 - {\tilde{f}}_{T}^{co} ) 𝒩 {A}_{J}} - \sqrt{{p}_{Δ}} .$$

In appendix F, the effect of [symbol] A_{J} on TBE is discussed in more detail. For now, it suffices to know that at fixed power and for Ση_{He}˜1, the TBE scales as

$$TBE ∼ \frac{1}{{\tilde{f}}_{T}^{co}} ( 1 + \frac{1}{\sqrt{\frac{4 {\tilde{f}}_{T}^{co} ( 1 - {\tilde{f}}_{T}^{co} ) 𝒩 {A}_{J}}{\sqrt{{p}_{Δ}}}} - 1} ) , \qquad ( 47 )$$

Where the exact form is given in equation (F7). Because the terms in equation (47) are typically of order unity, further simplification is challenging. The dramatic increase in the TBE as p_{Δ} and

$${\tilde{f}}_{T}^{co}$$

change in value around the resonance can be seen in FIGS. 9B and 10A.

Because of the resonance in equation (47), it is important to operate at a desirable

$${\tilde{f}}_{T}^{co}$$

value. To gain more intuition for the effect of

$${\tilde{f}}_{T}^{co} ,$$

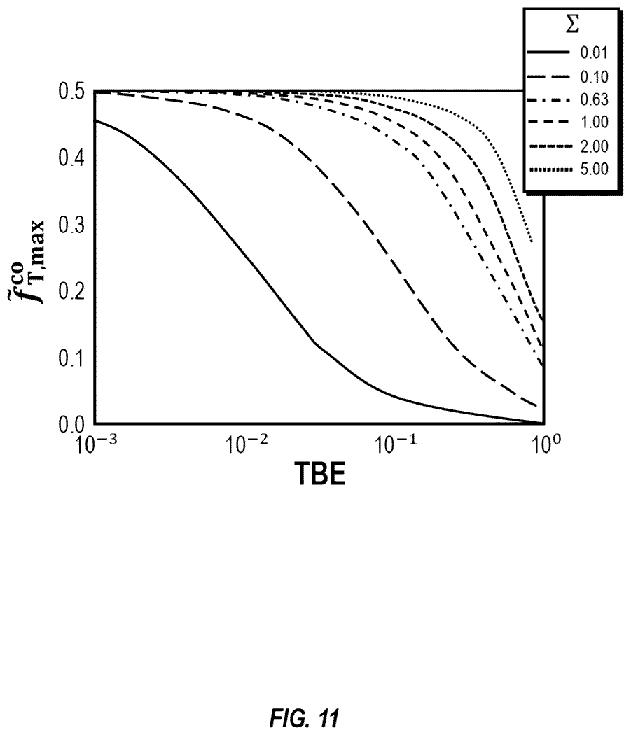

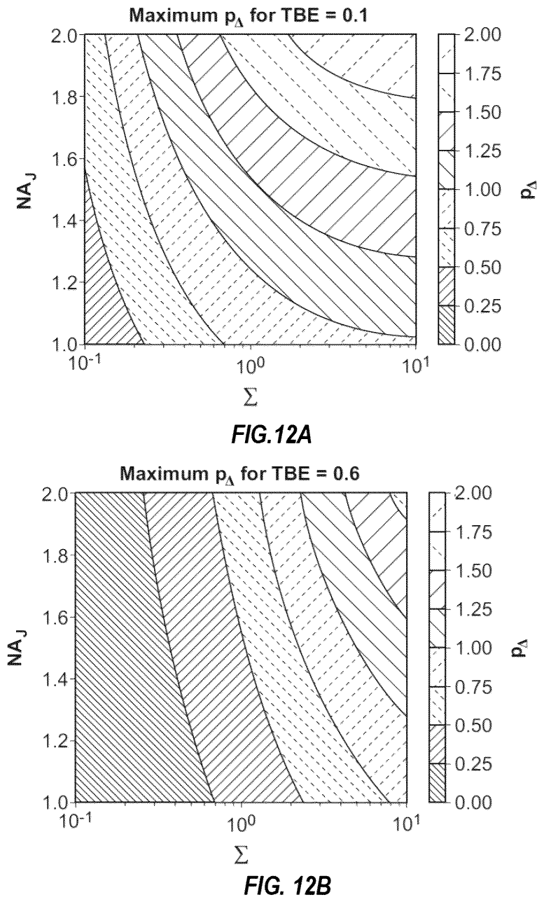

### in FIG. 11, the

$${\tilde{f}}_{T}^{co}$$

that gives the maximum power multiplier p_{Δ} is plotted for each TBE value over a range of Ση_{He} values. Only for Ση_{He}>1 is

$${\tilde{f}}_{T , max}^{co} ≃ 1 / 2$$

for a wide range of 1 DE values. Therefore, regardless of fuel polarization, if Ση_{He} is not sufficiently large, the maximum fusion power for moderate-high TBE will be maximized for

$${\tilde{f}}_{T}^{co}$$

significantly less than ½. It is again emphasized that the curves in FIG. 11 are obtained by holding Σ, η_{He}, [symbol] A_{J} fixed, and allowing TBE and other parameters such as ƒ_{He,div} to vary.

The maximum fusion power at fixed TBE occurs for

$${\tilde{f}}_{T , max}^{co} < 1 / 2$$

because of a competition between helium dilution effects and power density. At higher TBE, more tritium is burned and the alpha production is generally larger: as the TBE increases, so do ƒ_{He,div} and ƒ_{dil}, meaning that helium ash dilutes the plasma (see equations (43) and (44)). According to equation (36),

$${p}_{Δ} ∝ {\tilde{f}}_{T}^{co} ( 1 - {\tilde{f}}_{T}^{co} ) {( 1 - 2 {f}_{dil} )}^{2}$$

(neglecting spin polarization). Therefore, the prefactor

$${\tilde{f}}_{T}^{co} ( 1 - {\tilde{f}}_{T}^{co} ) {( 1 - 2 {f}_{dil} )}^{2} ,$$

will not have a maximum at

$${\tilde{f}}_{T}^{co} = 1 / 2$$

at moderate to high TBE because helium dilution effects can me the (1−2ƒ_{dil})² term very small for

$${\tilde{f}}_{T}^{co} = 1 / 2.$$

Formally, only for

$$TBE \to 0 is {\tilde{f}}_{T , max}^{co} \to 1 / 2$$

—in this unphysical limit, p_{Δ}→ [symbol] A_{J}.

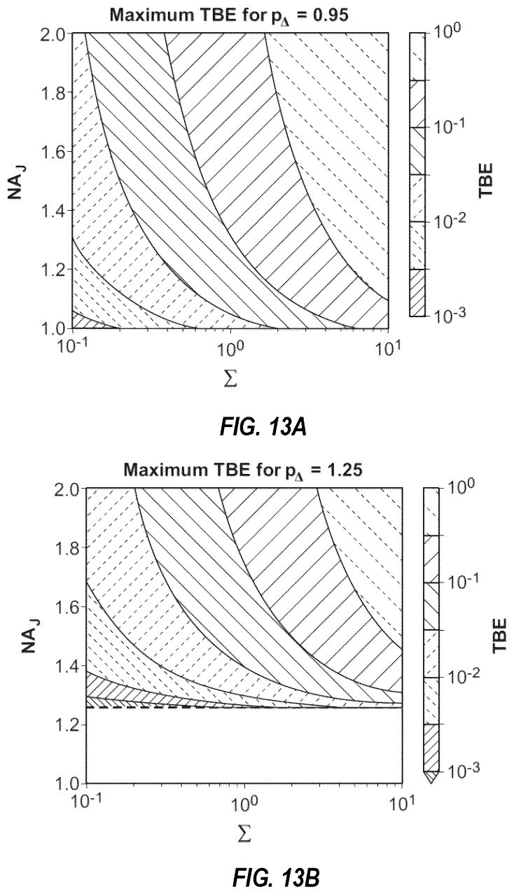

Σ, the ratio of helium to unburned hydrogen pumping speeds (see equation (27)) has been identified an important area for technological development, given that higher ¿ values can simultaneously enhance the TBE and fusion power. For a range of Σ and [symbol] Aⱼ values, the maximum achievable p_{Δ} for two different TBE values (and η_{He}=1.0) are plotted in FIG. 12: notably, increasing polarization and Σ work together to increase p_{Δ}. Furthermore, as the TBE and [symbol] Aⱼ increase, increasing Σ becomes increasingly important for increasing the fusion power. The beneficial effects of spin polarization on the TBE is also illustrated by comparing FIG. 13A and FIG. 13B where the maximum achievable TBE for p_{Δ}=0.95, and 1.25. Optimistically, lack of progress in improving Σ could be compensated for the SP fuels.

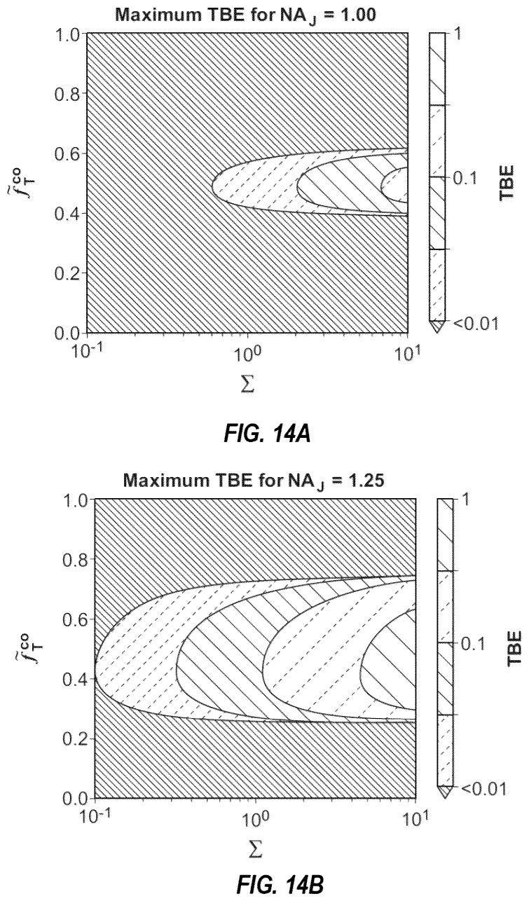

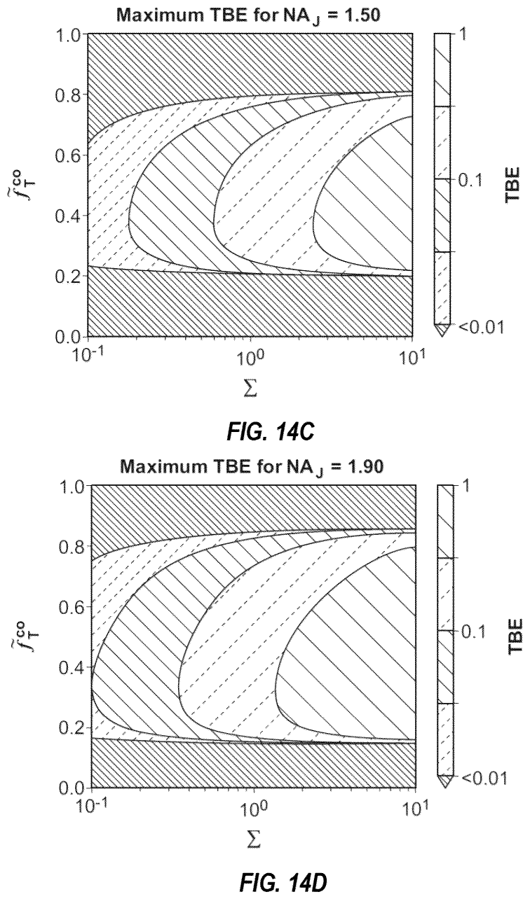

Comparing FIG. 14A, FIG. 14B, FIG. 14C, and FIG. 14D shows that SP fuels have a maximum TBE at lower

$${\tilde{f}}_{T}^{co}$$

and lower Σ than unpolarized fuels at fixed fusion power density, p_{Δ}=0.95, This demonstrates how the increased cross section given by SP fuels can be used to trade fusion power for tritium burn efficiency. For example, for unpolarized fuel in FIG. 14A, TBE=0.10 can be achieved with Σ≈4−5 and

$${\tilde{f}}_{T}^{co} ≃ 0.4 9 .$$

However, if the polarization is increased to NA_{J}=1.5, as in FIG. 14C, TBE=0.10 can be achieved with Σ≈0.5-0.6 and

$${\tilde{f}}_{T}^{co} ≃ 0.3 7 .$$

Because achieving NA_{J}=1.5 will likely be challenging—this requires all of the D-T fuel undergoing fusion reactions to be spin polarized, but neglects benefits the nonlinear power enhancement—also plotted is the TBE for an intermediate polarization, NA_{J}=1.25 in FIG. 14D. This value of A_{J}=1.25 is comparable to the upcoming D-He3 spin polarization experiments in DIII-D, but it is not known what N would correspond to in an equivalent D-T experiment. For NA_{J}=1.25, TBE=0.1 can be achieved with Σ≈0.40 and

$${\tilde{f}}_{T}^{co} ≃ 0.4 .$$

Finally, for the optimistic spin-polarization case, NA_{J}=1.9, a value of TBE=0.1 can be achieved with Σ≈0.12. Therefore, the required Σ for a given TBE (assuming

$${\tilde{f}}_{T}^{co}$$

can be varied) is highly non-linear in NA_{J}.

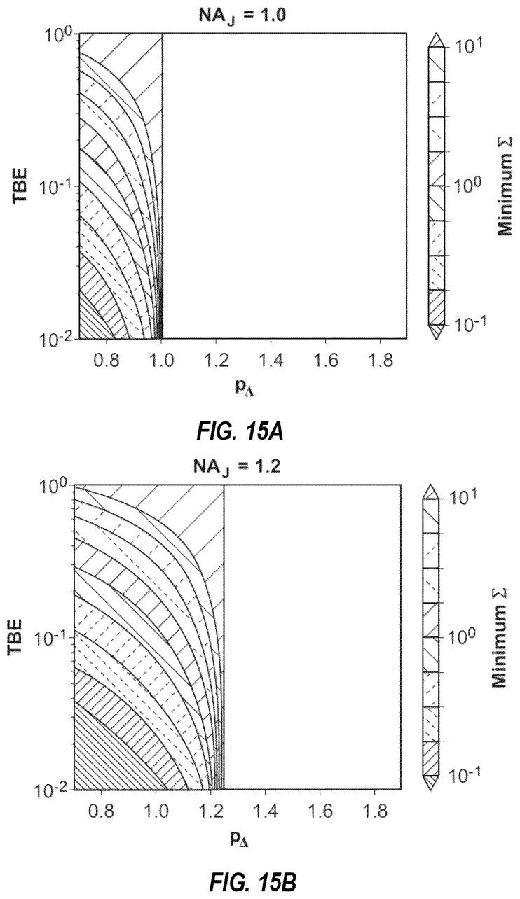

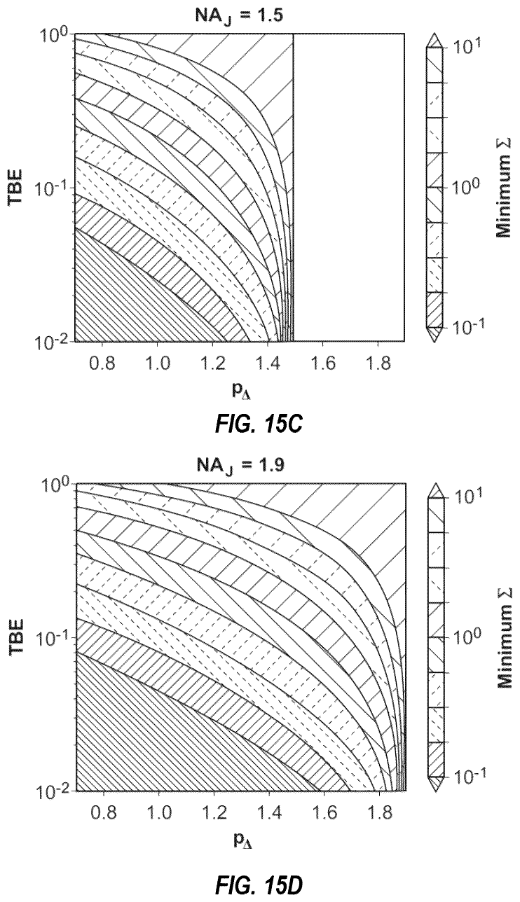

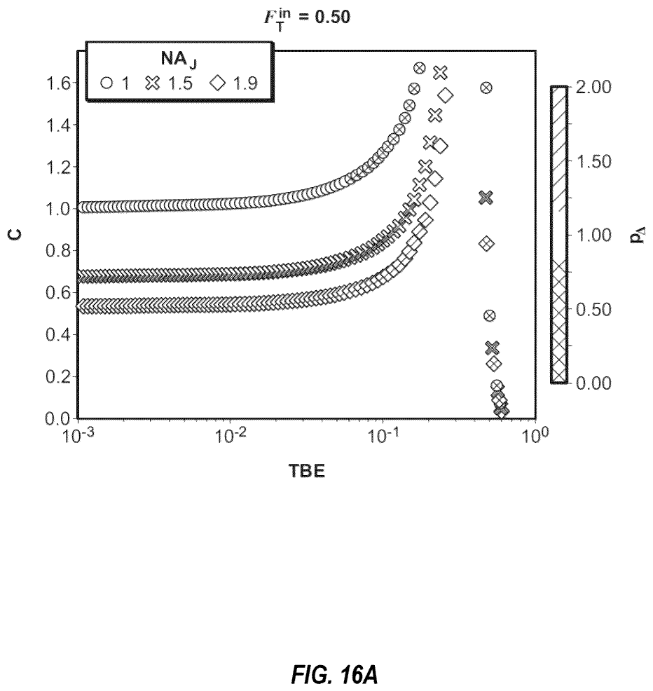

In FIG. 15, the minimum required pumping ratio Σₘᵢₙ versus TBE and p_{Δ} is plotted for four different polarizations NA_{J}. Comparing the four subfigures FIGS. 15A-15D demonstrate how high values of NAⱼ are beneficial for reducing the required Σ, especially for high p_{Δ} given how closely spaced the contours for different p_{Δ} values are at NA_{J}=1.9. Conversely, for lower p_{Δ} values, NAⱼ is not as useful for reducing Σₘᵢₙ a fixed TBE. For example, for p_{Δ}=0.7, the Σₘᵢₙ value is roughly only double for NA_{J}=1.0 than for NA_{J}=1.5. If one is willing to accept a relatively sever power degradation of p_{Δ}=0.7 but can achieve polarized fuel with NA_{J}=1.5, that increase in Σₘᵢₙ to increase the TBE would be relatively small, but would result in a large payoff in tritium burn efficiency. Fully exploring the parameter space of TBE, Σ, η_{He}, NA_{J},

$${\tilde{f}}_{T}^{co} ,$$

and p_{Δ} is beyond the scope of this present disclosure, but the results suggest that increasing [symbol] A_{J} using spin polarization combined with variable tritium fraction has unintuitively large, nonlinear benefits for the TBE, p_{Δ}, and Σₘᵢₙ.

### Fusion Gain

In this section, it's demonstrated how for a fixed plasma gain Q, spin polarization can give a TBE tens or even hundreds of times larger than that of unpolarized fuel.

Power balance in the core approximately requires

$${p}_{α} ( 1 + 5 / Q ) = \frac{{w}_{th}}{{τ}_{E}} \qquad ( 48 )$$

Where p_{α} is the alpha heating power density, Q=p_{f}/pₕₑₐₜ is the local plasma fusion gain (on a flux surface), pₕₑₐₜ is the hearing power density absorbed by the plasma, τ_{E} is the energy confinement time and wₜₕ is the stored thermal energy density. Also expressing the core thermal energy density as

$${w}_{th} = \frac{3}{2} ( {n}_{e} + {n}_{Q , co} ) {k}_{B} T + \frac{3}{2} {n}_{α} {k}_{B} 〈 {T}_{α} 〉 \qquad ( 49 )$$

Where the alpha particle pressure is

$${w}_{th , α} = \frac{3}{2} {n}_{α} {k}_{B} 〈 {T}_{α} 〉 \qquad ( 50 )$$

And the average temperature [symbol] T_{α} [symbol] accounts for the range of alpha particle energies. Here, it's assumed that the electron and ion temperatures have an equal value T—this approximation is discussed more in appendix D.3. Using quasineutrality, n_{Q,co}=nₑ−2n_{α}, equation (50) is

$${w}_{th} = 3 {k}_{B} TD \qquad ( 51 )$$

Where the dilution factor is

$$D ≡ ( 1 + {f}_{dil} ( \frac{1}{2} \frac{〈 {T}_{α} 〉}{T} - 1 ) ) \qquad ( 52 )$$

Which is equal to 1 when there are no helium dilution effects. One obtains

$${n}_{e} {τ}_{E} ( 1 + 5 / Q ) = \frac{15 {k}_{B} T}{〈 v \overline{σ} 〉 E / 4} \frac{( 1 + {f}_{dil} ( \frac{1}{2} \frac{〈 {T}_{α} 〉}{T} - 1 ) )}{4 {\tilde{f}}_{T}^{co} ( 1 - {\tilde{f}}_{T}^{co} ) {( 1 - 2 {f}_{dil} )}^{2}} \qquad ( 53 )$$

The second fraction on the RHS of equation (53),

$$C ≡ \frac{1 + {f}_{dil} ( \frac{1}{2} \frac{〈 {T}_{α} 〉}{T} - 1 )}{4 {\tilde{f}}_{T}^{co} ( 1 - {\tilde{f}}_{T}^{co} ) {( 1 - 2 {f}_{dil} )}^{2}} \qquad ( 52 )$$

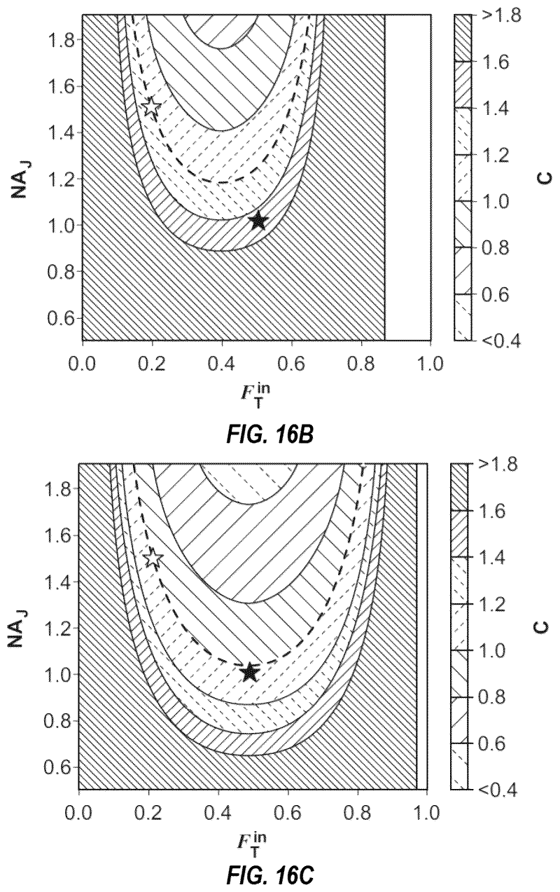

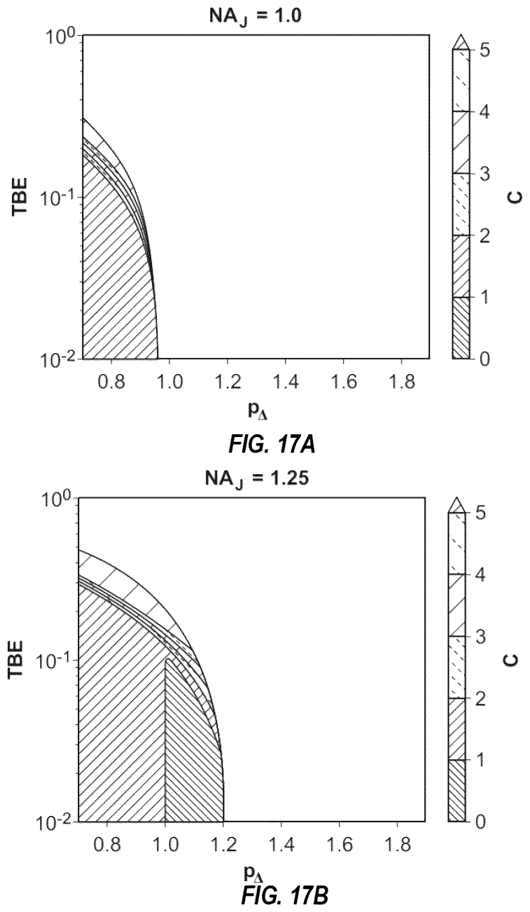

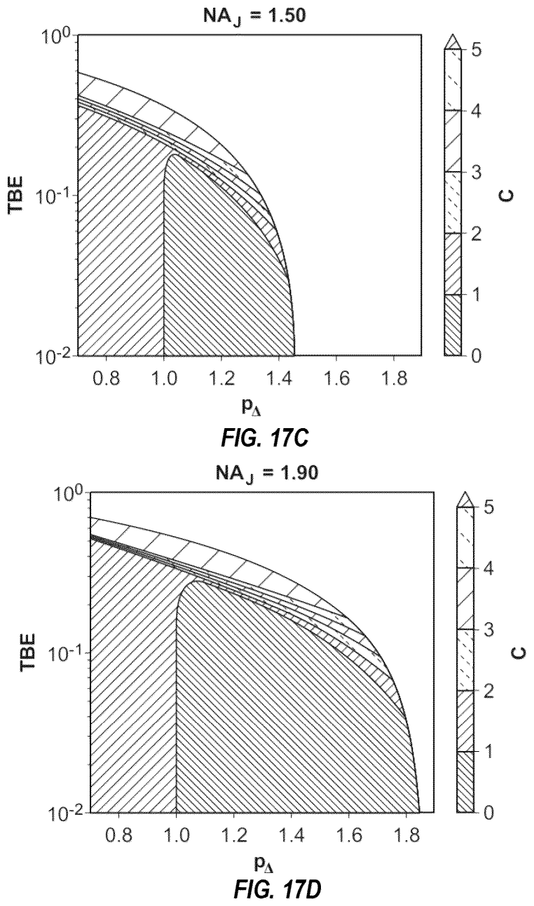

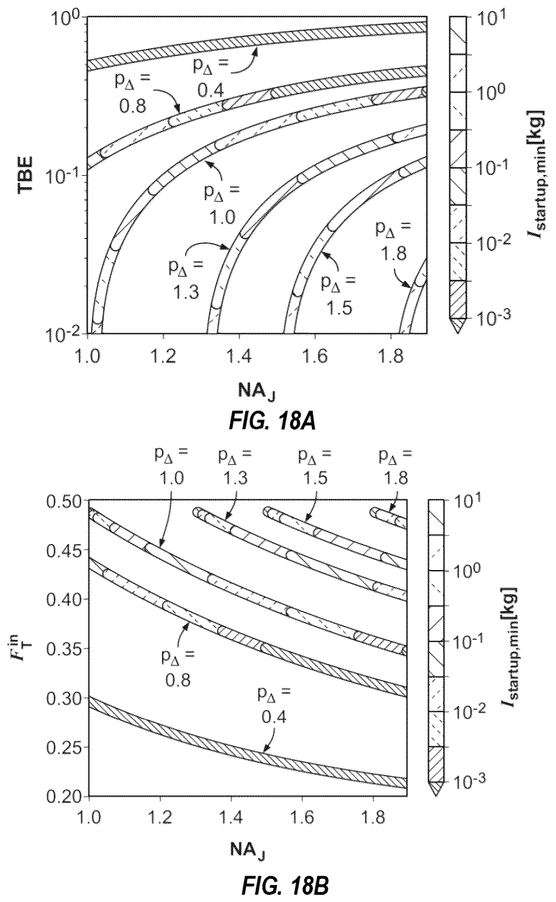

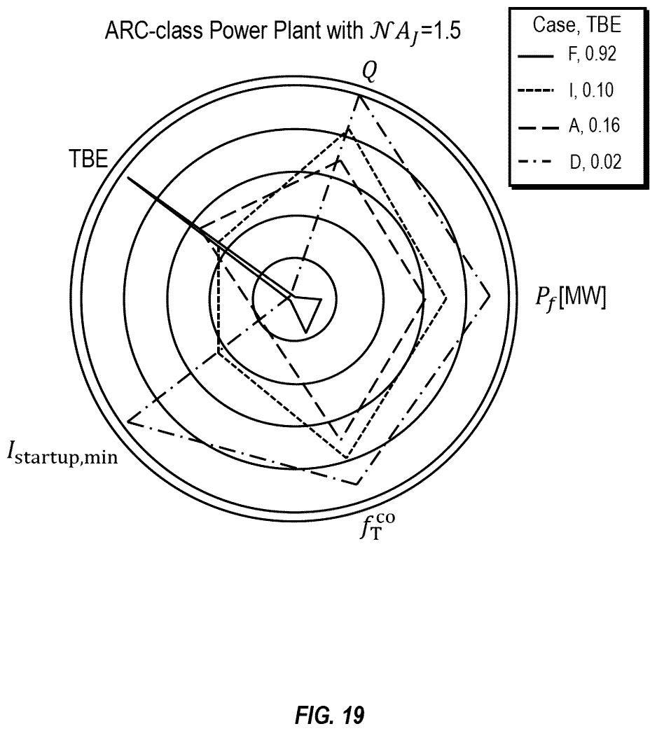

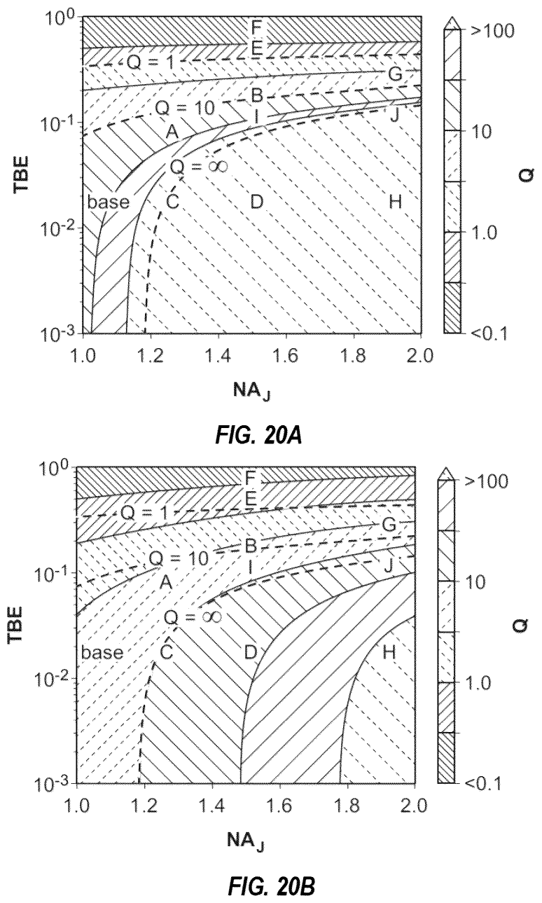

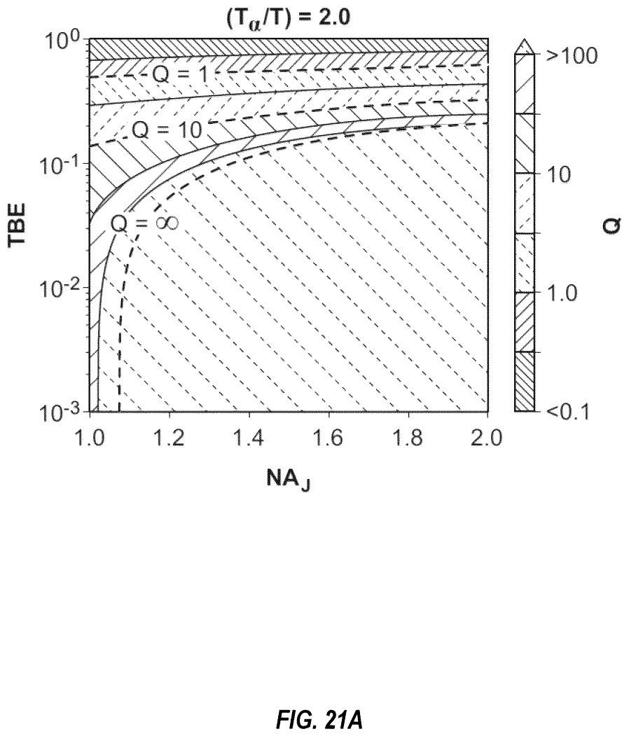

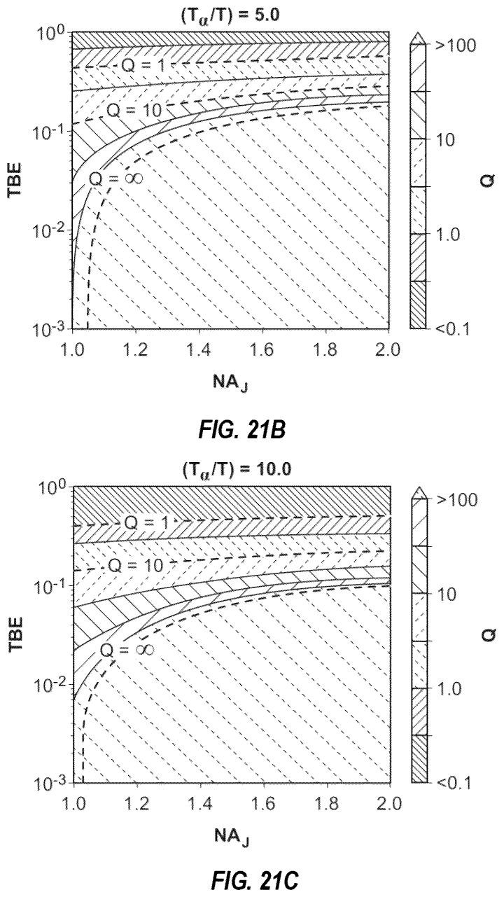

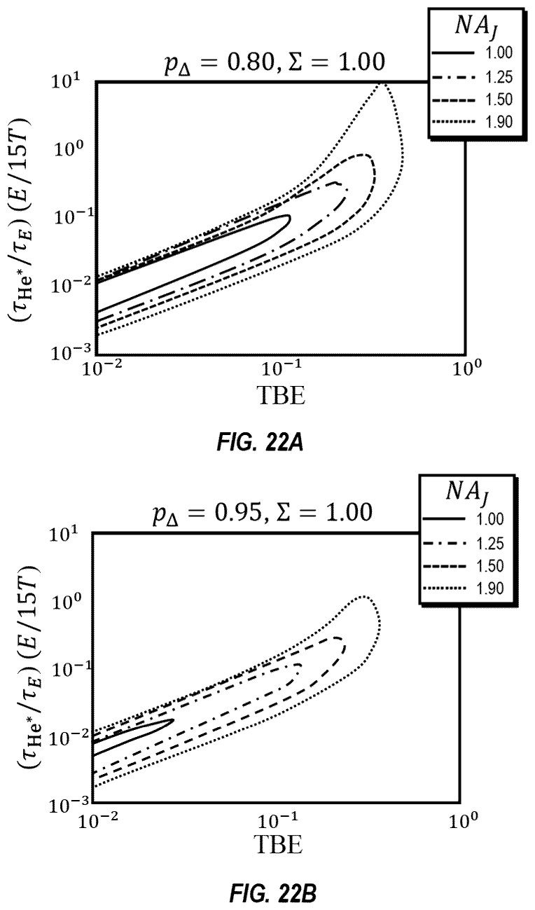

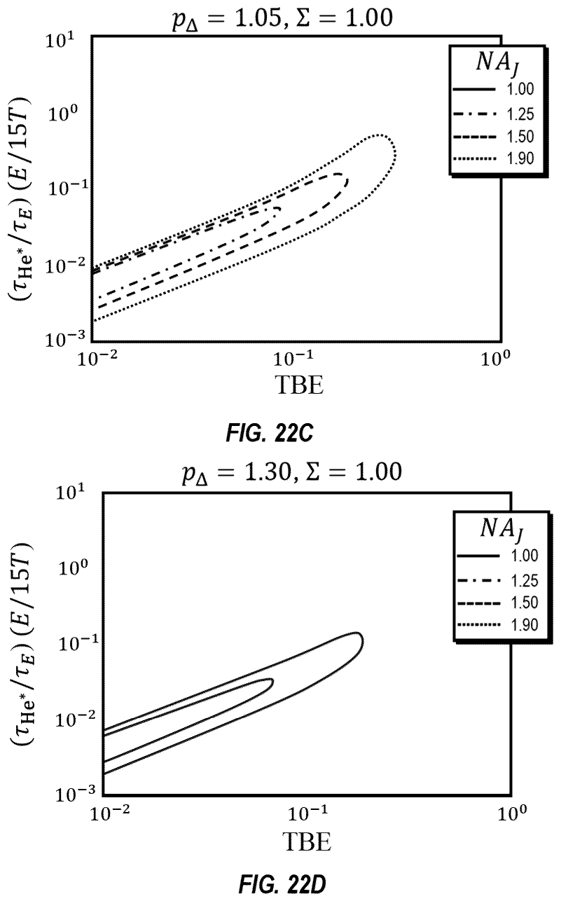

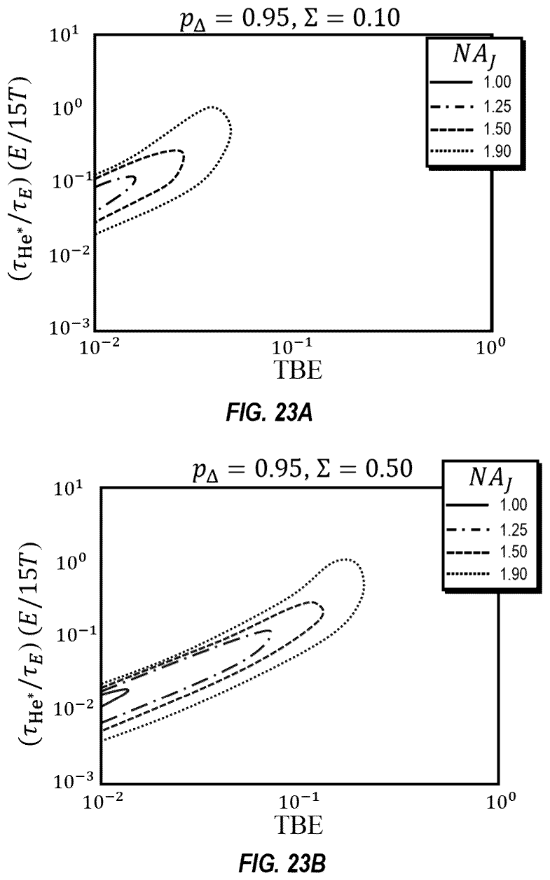

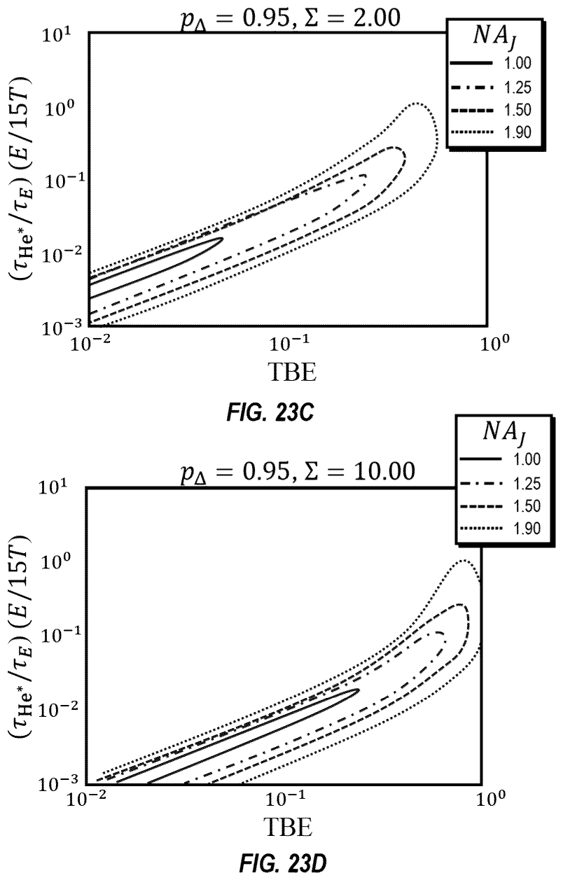

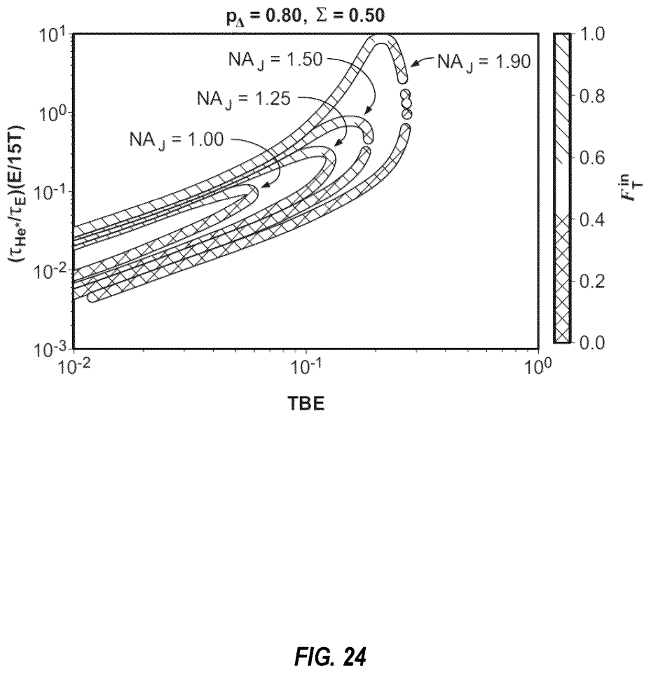

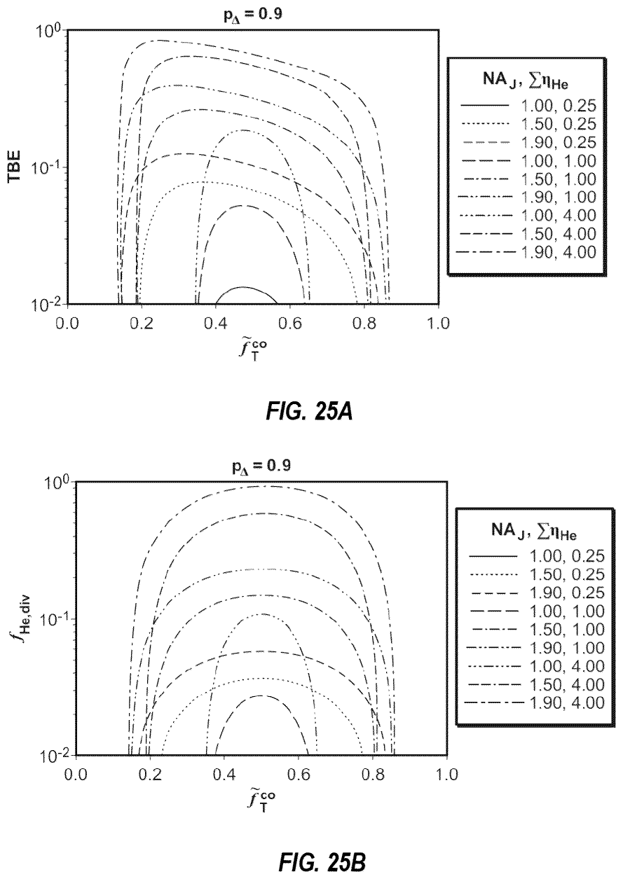

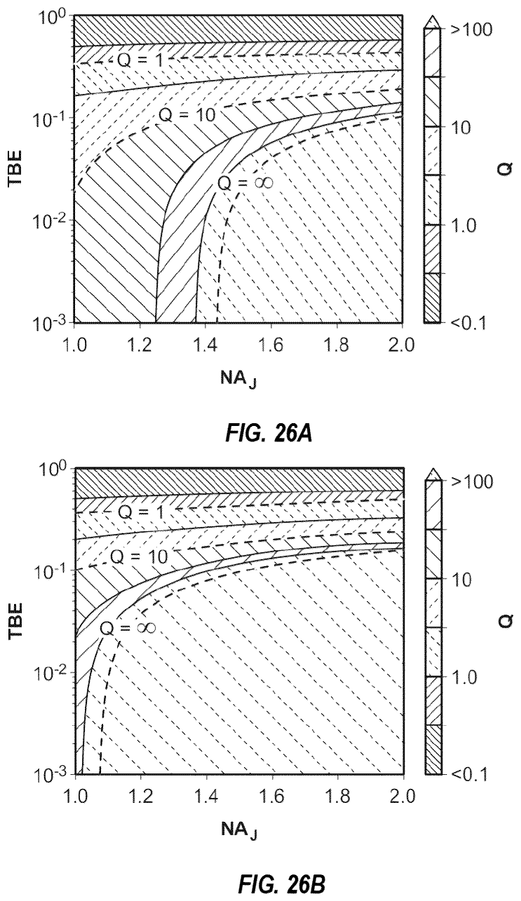

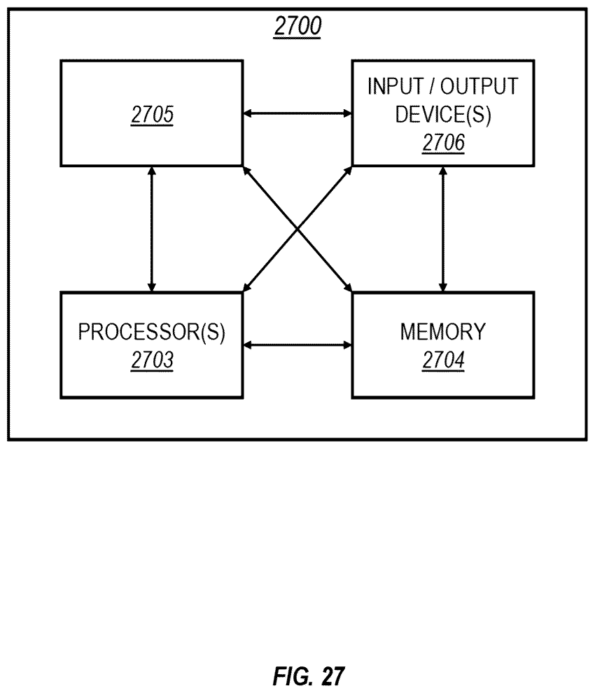

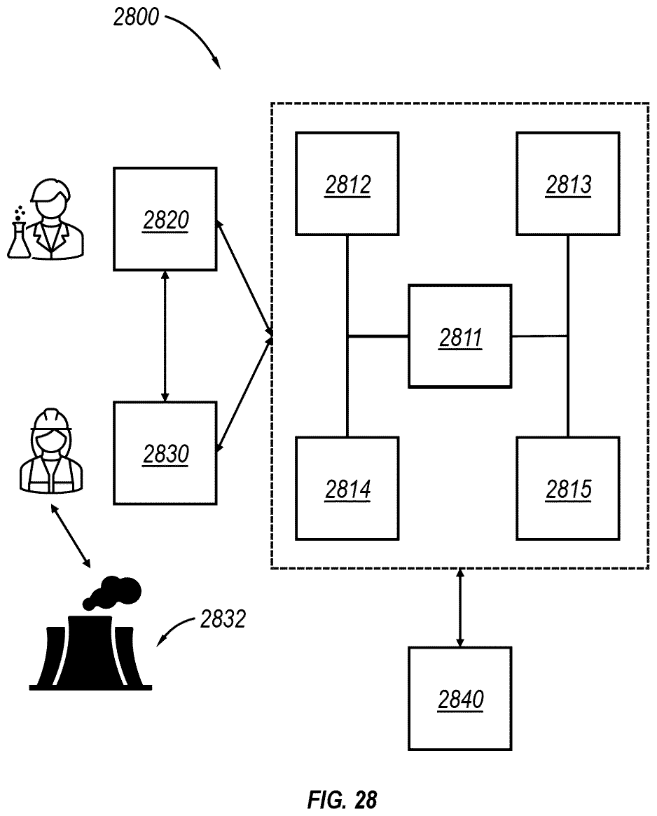

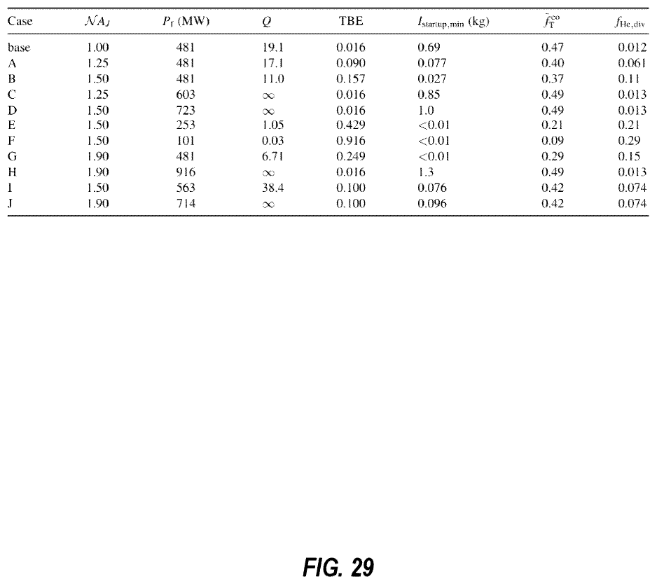

Is the required multiplier to keep [symbol] constant at fixed T. For simplicity, in this work, [symbol] T_{α} [symbol] =T is used. In FIG. 16A, C is plotted versus TBE for different

$${\tilde{f}}_{T}^{co}$$

and [symbol] A_{J} values. The results here are perhaps even more stark than earlier comparisons of how polarized fuel affects the TBE at fixed p_{Δ}. If one wishes to maintain [symbol] at fixed T, this requires C=1. Shown by the blue dash-dotted line in FIG. 16A [FIX DOTTED LINE DESCRIPTION], this formally gives TBE=0.00 for unpolarized fuel. However, for polarized fuel with NA_{J}=1.5, a reasonable TBE is achieved of TBE≈0.14. Ideally, one would operate a plant at a TBE value where TBE is as large as possible and Cis as small as possible. SP fuel makes the tradeoff between TBE and C much more favorable.

In FIG. 16B and FIG. 16C, C is plotted versus NAⱼ and

$${\tilde{f}}_{T}^{c o}$$

for TBE=0.15(b) an TBE=0.02 (c). At the given value of Ση_{He}=1.0, for a TBE=0.15 (b), only a very narrow range of

$${\tilde{f}}_{T}^{c o}$$

and NA_{J} values can achieve C≤1. Decreasing the TBE to 0.02(c), only plasmas with NA_{J}≤1.05 can achieve C≤1.

In FIGS. 17A-17D, the minimum fusion gain multiplier Cis plotted versus p_{Δ} and TBE for four NA_{J} values. Increasing NA_{J} not only increases the range of p_{Δ} values for which high gain (C≤1) regions are accessible, but also makes high gain accessible for a wider range of TBE values.

### Minimum Startup Inventory

As a short illustrative example, the effect of the tritium fraction and spin-polarization multiplier on the minimum startup inventory is calculated. As previously discussed, when a D-T fueled power plant starts up, it takes some time before tritium is bred in sufficient quantities to fully fuel the plant. During this initial phase, the power plant draws from a tritium startup inventory with mass Iₛₜₐᵣₜᵤₚ. As shown by others, the total time-dependent tritium inventory I_{storage} with zero tritium reserves can be expressed as

$$\begin{matrix}{I}_{storage} = {I}_{startup} + {\dot{N}}_{T , b u r n} ( T B R - 1 ) t \\ + {\dot{N}}_{T , burn} TBR \frac{{τ}_{IFC}^{2}}{{τ}_{O F C} - {τ}_{IFC}} ( 1 - {e}^{- t / {τ}_{IFC}} ) \\ + {\dot{N}}_{T , b u r n} TBR \frac{{τ}_{O F C}^{2}}{{τ}_{O F C} - {τ}_{IFC}} ( 1 - {e}^{- t / {τ}_{O F C}} ) \\ - {\dot{N}}_{T , burn} {τ}_{IFC} \frac{1 - TBE}{TBE} ( 1 - {e}^{- t / {τ}_{IFC}} )\end{matrix} \qquad ( 52 )$$

Here, TBR is the tritium breeding ratio, tis the time in seconds, and τ_{IFC} and τ_{OFC} are the tritium residence times for the inner and outer fuel cycle. The goal of this short exercise is to calculate the minimum startup inventory I_{startup,min} so that I_{storage} (t) always satisfies I_{storage} (t)≤0. For multiple values of power degradation p_{Δ} equation (45), I_{startup,min} is plotted in FIG. 18A and FIG. 18B versus TBE and polarization [symbol] A_{J}. The following set of parameters are assumed: τ_{IFC}=4h, τ_{OFC}=24h, TBR=1.08, and 9×10⁻⁷ kg s⁻¹ of tritium are burned for the zero power degradation case (corresponding to 507 MW of fusion power for an ARC-class device). The TBE is allowed to vary based on the combination of

$${\tilde{f}}_{T}^{c o} ,$$

NA_{J}, and p_{Δ}, and it's also assumed that Ση_{He}=0.63. For each value of NA_{J} and p_{Δ}, the TBE is self-consistently calculated from equation (45).

The results in FIG. 18A and FIG. 18B are striking: with zero power degradation p_{Δ}=1.0 in FIG. 18A, for NA_{J}=1.05 the minimum tritium startup inventory is over 4 kg, but as NA_{J} increases to NA_{J}=1.9, the startup inventory in the model decreases by over 3 and a half orders of magnitude. Note that \dot{N}_{T,burn} is constant on trajectories of constant p_{Δ}, and therefore the only variable changing Iₛₜₐᵣₜᵤₚ in equation (55) is the TBE. The significant decrease in I_{startup,min} at constant p_{Δ} due to polarization is therefore wholly due to the increase in TBE.

FIG. 18B shows I_{startup,min} versus

$${F}_{T}^{i n}$$

and NA_{J} for the same range of p_{Δ} values. Notably, operating a power plant with

$${F}_{T}^{i n} = 0.5$$

needlessly increases I_{startup,min} to several kilograms for all the NA_{J} values considered here. Therefore, regardless of NA_{J} value, there are significant gains in tritium efficiency to be made by small decreases in

$${F}_{T}^{i n}$$

(and therefore p_{Δ}).

A notable benefit of polarization on I_{startup,min} is that very small increases in [symbol] Aⱼ at constant fusion power can have large effects: even a 5% increase in NA_{J} from NA_{J}=1.00 to NA_{J}=1.05 for p_{Δ}=1.0 could decrease the required minimum startup inventory by a factor of ten.

Finally, it is worth noting just how small the I_{startup,min} values are at large NA_{J}. While I_{startup,min}˜10⁻³ kg is not realistic—there will be other factors driving the tritium startup inventory size—this exercise has shown how high TBE values accessed with high polarization values can minimize the impact of tritium burn on the initial startup inventory size.

The benefits of smaller tritium startup inventory with spin-polarized fuel are substantial. Not only could lower startup inventory requirements prevent possible tritium availability shortages, but combined with higher tritium burn efficiency, could reduce the total amount of tritium retained in the plant. ITER, for example, has an administrative limit on the total tritium retainment of 700 grams, which limits the number of discharges, constraining other parts of the design, notably the wall and divertor materials.

### ARC-Like Power Plant

In this section, a brief summarization of the main effects of spin polarization on the primary metrics for fusion power and tritium self-sufficiency is given by analyzing an ARC-like device. Using similar parameters to those used elsewhere (also used in the previous section), key parameters are calculated for seven operating scenarios with varying levels of spin polarization. These are summarized in Table II. All scenarios in Table II have τ_{IFC}=4h, τ_{IFC}=24h, TBR=1.08, Σ=1.0, and η_{He}=0.63. More details for this section's workflow are provided in appendix C. For a quick summary, compare the base scenario and cases I and J in FIG. 3. The relative location of all the cases is plotted in the plasma gain and fusion power plots in FIG. 18A and FIG. 18B.

In order to obtain the parameters for the following cases, two main approaches were followed: (1) specify the desired fusion power through p_{Δ} and optimize the

$${F}_{T}^{i n}$$

value to find the highest TBE, and (2) specify the TBE and optimize the

$${F}_{T}^{i n}$$

value to find the highest p_{Δ}. For each case, all of the dependent parameters such as ƒ_{He,div}

$${f}_{T}^{sep} ,$$

etc., ale checked to ensure they are within physical limits.

Cases A and B have the same power as Base of 481 MW, and use spin polarization to significantly increase the TBE and decrease the minimum startup inventory I_{startup,min}. Increasing [symbol] _{J} from 1.0 to 1.5 decreases I_{startup,min} from 0.69 kg to 0.0027 kg. In Base, A, and B, the tritium fraction

$${\tilde{f}}_{T}^{c o}$$

is chosen to maximize the TBE. As expected by previous discussions (e.g., surrounding FIG. 10), the improvement of the TBE with NA_{J} is nonlinear. Notably, at higher NA_{J} values, the divertor helium fraction ƒ_{He,div} increases significantly. The most promising result between Base, A, and B, is that I_{startup,min} already decreases by 88% when increasing NAⱼ from 1.0 to 1.25 (50% fuel polarization). This is consistent with results in section 5 that achieving 100% fuel polarization is not necessary to significantly increase the TBE and therefore decrease I_{startup,min}.

In C and D, spin polarization is used to maximize the fusion power constrained to the same TBE value as the Base scenario, TBE=0.016. In the model, the fusion power scales with NA_{J} at fixed TBE. Case C with NA_{J}=1.25 has p_{f}=603 MW and Case D with NA_{J}=1.50 has p_{f}=723 MW. In C and D, the tritium fraction

$${\tilde{f}}_{T}^{c o}$$

is chosen to maximize the fusin power.

Notably, in the tritium model in equation (55), tritium startup inventory increases linearly with NA_{J} in C and D compared with the Base scenario. This is because it's assumed that the TBR is constant. And therefore because p_{f}∝\dot{N}_{T,burn} in equation (55), I_{startup,min}∝Aⱼ. This may not be realistic.

Cases E and F in Table II are included to illustrate extremely high tritium burn up regimes. Case F operates with a very low tritium fraction,

$${\tilde{f}}_{T}^{c o} = 0.09 ,$$

has a very low fusion power, p_{f}=101 MW, but achieves TBE=0.916: for every ten tritium particles injected in the reaction chamber, more than nine of them undergo fusion events.

As a demonstration of just how far spin polarization positively affects tritium self-sufficiency and fusion power, one may consider cases G and H with very high spin polarization and power enhancement, NA_{J}=1.9. Case G is designed to maximize the TBE and minimize I_{startup,min}, and case H is designed to maximize the fusion power. Case G achieves TBE=0.249 and I_{startup,min}=<0.01 kg, and case H achieves p_{f}=916 MW but requires I_{startup,min}=1.3 kg according to the tritium inventory model in equation (55).

Finally, one may consider two compromise cases, I and J, where both the tritium self-sufficiency and fusion power are improved, rather than the cases in cases A-H where either the tritium self-sufficiency or fusion power is maximized. An optimized search in the TBE was not performed but TBE=0.10 was chosen.

Case I has [symbol] A_{J}=1.50 and TBE=0.10. This gives a fusion power of 563 MW, I_{startup,min}=0.076 kg and

$${\tilde{f}}_{T}^{c o} = 0.42 .$$

Case J has the same inputs as case I except its spin-polarization multiplier is higher, NA_{J}=1.9. This gives a fusion power of 714 MW, I_{startup,min}=0.096 kg and

$${\tilde{f}}_{T}^{c o} = 0.42 .$$

In both of these cases. ƒ_{He,div}=0.074. Cases I and J are compared with the base case in FIG. 3.

In FIG. 19, a spider plot is used to summarize the effect of TBE at fixed NA_{J}=1.5 fir cases A, D, F, and I. Increasing the TBE decreases

$${\tilde{f}}_{T}^{c o} ,$$

Q, P_{f}, and I_{startup,min}. Cases A and I are likely good candidate cases that compromise between increased TBE and increased p_{f}, Q.

The plasma gain values in table II are particularly striking. For a detailed description of how these [symbol] values were calculated, See appendix C. Briefly, the [symbol] values were calculated at fixed nₑTτ_{E}, and account for helium dilution, tritium fraction, and spin-polarization effects (see equation (54)). In order to better compare the different cases, the [symbol] values are plotted against TBE and NA_{J} in FIG. 20A. As shown by cases C, D, and H in FIG. 20, the power plant ignites for a wide range of NAⱼ values. Inspection of FIG. 20A at very low TBE values reveals that for the parameters chosen here, this power plant could ignite at NAⱼ≈1.18. Optimistically, this value if spin polarization, NAⱼ≈1.18, is very low compared with the spin-polarization power boost from recent simulations NAⱼ≈1.9. Notably, as shown by the fusion power in FIG. 20B, p_{f} still increases significantly in ignited plasmas, from a minimum of p_{f}≈600 MW to a maximum of p_{f}≈1000 MW for the TBE and NAⱼ values shown.

Additionally, these results suggest that the upcoming SPARC experiment might achieve ignition with moderately high values of NAⱼ≥1.42. In appendix H, the same exercise is performed but with a nominal plasma gain of Q=10 and Q=40 rather than the Q=20 used here. At very low TBE, for the nominal Q=10 case, ignition is predicted for NAⱼ≥1.42 and for the nominal Q=40 case, ignition is predicted for NA_{J}≥1.06.

This short case study has demonstrated that spin polarization can simultaneously improve a fusion power plant's burn efficiency, increase the fusion power, and decrease the tritium startup inventory. For case J in table II, operating with spin-polarized fuel increases the fusion power by 52%, increases the TBE by 525% and decreases the startup tritium inventory by 84%. A future question to answer is whether the increased ƒ_{He,div} at higher TBE is feasible. Although operating at higher ƒ_{He,div} could be concerning, in this exercise ƒ_{He,div} is increasing because the hydrogen divertor density is increased; the helium divertor removal rate \dot{N}_{He,div} and density are fixed because the fusion power is constant. Operating at high spin polarization and high TBE might be challenging because the plasma is very efficient with both tritium and deuterium, resulting in low hydrogen divertor density. If spin-polarized plasmas were to be operated at high TBE, mitigating the potentially negative impact on the power exhaust would be crucial.

See appendix F for further discussion of the TBE and ƒ_{He,div} and See appendix D.2 for a discussion of the limitations of the constant TBR assumption used in this study. In other studies, it was suggested that a high TBE could give an unreasonably long helium particle confinement time. This is of particular concern for spin-polarized plasmas with very high TBE. This question is studied in appendix E and a conclusion is give that while spin-polarized plasmas with high TBE do have longer helium particle confinement times, they do not exceed dimensionless thresholds measured in current experiments.

### DISCUSSION

It's proposed using spin-polarized fuels to significantly enhance tritium burn-up rates in a magnetized confinement fusion power plant, increasing efficiency from a few percent to multiple tens of percent. Drawing from recent work, it's shown that burning plasmas using D-T polarized fuel can increase the tritium burn efficiency by at least an order of magnitude over unpolarized fuels with no degradation in power density. If the power density is allowed to increase significantly with spin-polarized fuel, the tritium burn efficiency can still increase by a factor of five to ten. This could significantly improve the economic viability of D-T power plants with high tritium self-sufficiency.

In one example based on the power increase using spin-polarized fuels, an ARC-like fusion power plant with spin-polarized fuel increases the fusion power by 52%, increases the TBE by 525%, and decreases the startup tritium inventory by 84% relative to the plant operating with unpolarized fuel (see case J in table II and FIG. 3). In another example where a power plant using spin-polarized fuel maintains the same fusion power as unpolarized fuel and the increased cross section is used solely for improved tritium burn efficiency (see case G in table II), the TBE increases by 1425% to TBE=0.25 and the predicted tritium startup inventory falls 99% to less than 10 grams. This demonstrates that the increased cross section conferred by spin-polarized fuels gives a significant advantage in tritium burn efficiency, in addition to the widely recognized increase in power density. Operating with spin-polarized fuel can also drastically reduce improvements in the helium pumping efficiency required to obtain a given fusion power and tritium burn efficiency (see FIG. 15), sometimes by an order of magnitude. The unexpectedly large increase in the TBE for spin-polarized D-T is due to a double benefit of operating at lower tritium fraction and lower overall hydrogen fueling (see discussion surrounding FIG. 8 and appendix F)), as well as the fusion power scaling linearly with spin polarization.

It's also shows that in some points of parameter space, very small increases in the fuel's spin polarization could decrease the tritium startup inventory by an order of magnitude. For an ARC-class device, the tritium startup inventory could be reduced to less than one hundred grams, with a moderate power increase (see FIGS. 3, 18, and table II). If spin-polarized fusion is demonstrated with high polarization survivability, the results in this work suggest that tritium startup and circulating inventory could be significantly reduced. This shows that spin-polarized fusion fuels, although undemonstrated and speculative, could significantly lower the technological requirements and costs for a power plant with high tritium self-sufficiency, even if only modest polarization fractions are achieved.

### Appendix A

In this section, the relation between the core tritium fraction

$${f}_{T}^{c o}$$

and the core tritium flow fraction

$${F}_{T}^{c o}$$

is shown. The tritium flow rate through a flux surface is

$${\dot{N}}_{T}^{c o} = {V}^{′} 〈 ∇ r 〉 {Γ}_{T} \qquad ( A1 )$$

Where V′=dV/dr for the flux-surface volume V and minor radial-flux density

$${Γ}_{T} = - {D}_{T} ∇ {n}_{T} , \qquad ( A 2 )$$

Where Dr is a diffusion coefficient, the tritium flow rate becomes

$${\dot{N}}_{T}^{c o} = - {V}^{′} 〈 ∇ r 〉 {D}_{T} ∇ {n}_{T} \qquad ( A 3 )$$

The total hydrogen flow rate is

$${\dot{N}}_{T}^{c o} = - {V}^{′} 〈 ∇ r 〉 ( {D}_{T} ∇ {n}_{T} + {D}_{D} ∇ {n}_{D} ) \qquad ( A 4 )$$

Several simplifying assumptions are made. First, it's assumed that the deuterium and tritium densities satisfy

$$∇ {n}_{D} ≃ \frac{1 - {f}_{T}^{c o}}{{f}_{T}^{c o}} ∇ {n}_{T} \qquad ( A 5 )$$

Where it's assumed that

$$∇ ( \frac{1 - {f}_{T}^{c o}}{{f}_{T}^{c o}} {n}_{T} ) ≃ \frac{1 - {f}_{T}^{c o}}{{f}_{T}^{c o}} ∇ {n}_{T} \qquad ( A 6 )$$

And the following is used

$${n}_{D} = \frac{1 - {f}_{T}^{c o}}{{f}_{T}^{c o}} {n}_{T} \qquad ( A 7 )$$

It's also assumed that deuterium and tritium diffusion coefficients are equal D=D_{D}=D_{T}, which while not disproven for previous D-T experiments, may not hold for burning plasmas. This gives

$${\dot{N}}_{Q}^{c o} = - {V}^{′} 〈 ∇ r 〉 D \frac{∇ {n}_{T}}{{f}_{T}^{c o}} . \qquad ( A 8 )$$

Using these assumptions to write the tritium flow rate,

$${\dot{N}}_{T}^{c o} = - {V}^{′} 〈 ∇ r 〉 D ∇ {n}_{T} , \qquad ( A 9 )$$

Results in the tritium flow rate fraction being equal to the tritium density fraction,

$${F}_{T}^{c o} = \frac{{\dot{N}}_{T}^{c o}}{{\dot{N}}_{Q}^{c o}} = {f}_{T}^{c o} . \qquad ( A 10 )$$

In summary, to derive equation (A10), three main simplifications were used: diffusive particle transport in equation (A2) m neglecting the spatial gradient of

$${F}_{T}^{c o}$$

in equation (AD) and D=D_{D}=D_{T}. Interesting future extensions of this model might study the effect of D_{D}≠D_{T}, keeping terms proportional to

$$∇ ( 1 / {f}_{T}^{c o} )$$

in equation (A6), and adding a particle pinch term.

### Appendix B. Particle Transport Equation

In this section, the derivation of and assumptions in equations (11) and (12) are described. First, in steady state, the tritium particle transport equation is

$$∇ {( \cdot Γ )}_{T} = {S}^{in} - {S}^{fusion} . \qquad ( B1 )$$

Where Sⁱⁿ is the particle injection source and S^{fusion} is the D-T fusion sink. Performing a volume integral from the magnetic axis to a flux surface that encloses the fraction ƒ_{burn} of the total fusion power p_{f}

$$( and therefore tritium burn {N}_{T}^{burn} )$$

and the fraction ƒᵢₙ of the total injected tritium gives

$${\dot{N}}_{T}^{co} = {f}_{in} {\dot{N}}_{T}^{in} - {f}_{burn} {\dot{N}}_{T}^{burn} \qquad ( B2 )$$

Here, it is used that the core particle flow rate on a flux surface ƒ_{burn} is

$${\dot{N}}_{T}^{co} = \int ∇ \cdot {Γ}_{T} dV = {\int }_{S} {Γ}_{T} \cdot dS , \qquad ( B3 )$$

Where the surface area integral dS is evaluated over the flux surface ƒ_{burn}. Finally, it's assumed that all of the fueling occurs on the magnetic axis so that ƒᵢₙ=1.0. Thus, equation (B2) becomes

$${\dot{N}}_{T}^{co} = {\dot{N}}_{T}^{in} - {f}_{burn} {\dot{N}}_{T}^{burn} , \qquad ( B4 )$$

And for the total unburned hydrogen

$${\dot{N}}_{Q}^{co} = {\dot{N}}_{Q}^{in} - 2 {f}_{burn} {\dot{N}}_{T}^{burn} , \qquad ( B5 )$$

### Appendix C. ARC-like Device Workflow

In this section, the steps to calculate the parameters in table II are outlined. The model inputs are [symbol] A_{J}, Σ=1.0, η_{He}=0.63, τ_{IFC}=4h, τ_{OFC}=24h, and TBR=1.08.

For the Base Case the fusion power is set to p_{f}=481 MW the nominal plasma gain Q₀=10.0, and the polarization multiplier [symbol] A_{J}=1.0. For these parameters, the aim is to maximize the TBE by rearranging equation (45) for TBE and assuming that p_{Δ}=0.95. One then finds the

$${\tilde{f}}_{T}^{co}$$

value that gives the highest TBE, which is equivalent to allowing ƒ_{He,div} to vary (see equation (44)). Using the procedure outlined in “Minimum Startup Inventory”, the minimum tritium startup I_{startup,min} is calculated using equation (44).

Cases A and B in table II follow a similar procedure to the Base Case. The objective is to maximize the TBE at fixed power. The total fusion power is fixed at p_{f}=481 MW but higher values of [symbol] A_{J} are chosen. Again, using equation (45), one fins the

$${\tilde{f}}_{T}^{co}$$

value that gives the highest TBE. Because [symbol] Aⱼ is higher, a higher

$${\tilde{f}}_{T}^{co}$$

value can be achieved at fixed P_{f}. To find the new plasma gain Q, it's assumed that nₑτ_{E}, and T in equation (54) are constant. Thus, one can write 1+Q₀/5=kC₀, where C₀ is the nominal multiplier to keep Q constant in equation (54) and k is a constant of value

$$k = \frac{1 + 5 / {Q}_{0}}{{C}_{0}} \qquad ( C1 )$$

This allows one to write an equation for Q

$$Q = \frac{5}{kC - 1} \qquad ( C2 )$$

The plasma ignition criterion is

$$kC < 1 , \qquad ( C3 )$$

Which some of the ARC-like cases are shown to satisfy in FIG. 18A and FIG. 18B.

For cases C and D, the objective is to find the maximum fusion power for a given [symbol] A_{J} using the TBE value for the base case. For these cases with two different NAⱼ values, equation (45) is used to find the

$${\tilde{f}}_{T}^{co}$$

value that gives the highest fusion power. Following this, I_{startup,min}, Q, and ƒ_{He,div} are found.

For cases E and F, the objective is to find the maximum TBE for a given power degradation pΔ=0.50, 0.25 respectively. Again, using equation (45) the

$${\tilde{f}}_{T}^{co}$$

value that maximizes the TBE IS found and I_{startup,min}, Q and ƒ_{He,div} are found.

Cases G and H are illustrative examples with very high polarization multiplier NA_{J}=1.9. Case G maximizes the TBE at fixed power in the same way as Cases A and B. Case H maximizes the fusion power for a given NAⱼ using the TBE value for the base case. This is the same workflow as Cases C and D.

For cases I and J that simultaneously increase the fusion power and the TBE, one follows the same workflow as C and D, only in this case one increases the TBE to TBE=0.10.

### Appendix D. Limitations

In this section, a brief description of some of the limitations of the analysis in this work is given.

### D.1. Constant T Assumption

When calculating the fusion gain multiplication factor C in equation (53), it's assumed that T is constant. This will cause errors when N≠1 because equation (54) is derived assuming constant T. Physically, [symbol] ≠1 describes the effects of alpha heating changing the temperature and hence the fusion reactivity. To incorporate effects of changing temperature one could use that for T between 10 and 20 keV that [symbol] νσ̅ [symbol] ˜T², and hence use T˜ [symbol] . However, given that the largest value of N in this work is bounded by N<1.9/Aⱼ (since it's considered that NA_{J}≤1.9), if one sets A_{J}=1.5, the maximum value of N is N≈1.27, and thus [symbol] ≤1.13. Such an effect is beyond the scope of this work by may be important.

### D.2. Constant TBR Assumption

When calculating the tritium startup inventory in “Minimum Startup Inventory” and “ARC-like power plant”, it's assumed that the tritium breeding ratio (TBR) is independent of tritium burn efficiency (TBE). This is despite work showing that the required TBR, TBRᵣ is reduced most by the TBE and the tritium doubling time. As a quick sanity check, one calculates I_{startup,min} for case J of the ARC-like power plant in “ARC-like power plant”. For the nominal TBR value used, TBR=1.08, I_{startup,min}=0.096 kg. Using TBR=1.04 and keeping everything else constant, the startup requirement increases by 2% to I_{startup,min}=0.098 kg. Increasing the TBR significantly to TBR=1.15, the startup requirement decreases by 6% to/I_{startup,min}=0.090 kg. Within the model used in this work, keeping TBR constant has a relatively small effect on I_{startup,min} compared with other parameters, most notably the tritium fraction

$${\tilde{f}}_{T}^{co}$$

and the spin-polarization multiplier NA_{J}.

### D.2. Constant TBR Assumption

In this work, the following is used [symbol] T_{α} [symbol] =T. In FIG. 21, the effect of [symbol] T_{α} [symbol] /T=2, 5 and 10 on the plasma gain for a power plant is shown with a nominal gain of Q=40. At low TBE, the effect is negligible, but at higher TBE the change in the fusion gain can be of order unity. Higher fidelity modeling is required to further investigate the effect of [symbol] T_{α} [symbol] /T.

There are other limitations inherent in the approach here: no impurities, no alpha particle deposition model, no fueling model. Higher fidelity modeling is needed to study these effects.

### Appendix E. Helium Particle Confinement

In this section, the helium confinement time ratio τ*ₕₑ/τ_{E} is calculated. A helium exhaust study of JT-60U found that τ*ₕₑ/τ_{E}≤10—a plasma operating regime that significantly exceeding this bound would require justification. One wishes to test whether τ*ₕₑ/τ_{E} exceeds τ*ₕₑ/τ_{E}≈10 for very high TBE values that are possible with spin polarization (see FIGS. 10 and 12). Defining the helium particle confinement time

$${τ}_{He}^{*} ≡ \frac{{n}_{α}}{{\dot{n}}_{α}} , \qquad ( E1 )$$

Where the alpha particle birth rate density is

$${\dot{n}}_{α} ≡ {\tilde{f}}_{T}^{co} ( 1 - {\tilde{f}}_{T}^{co} ) {( 1 - 2 {f}_{dil} )}^{2 𝒩} {A}_{J} {n}_{e}^{2} 〈 v σ 〉 . \qquad ( E2 )$$

Substituting 1-2ƒ_{dil} from equation (E2) into equation (53) and using equation (E1), one finds that τ*ₕₑ/τ_{E} is

$$Y ≡ \frac{{τ}_{HE}^{*}}{{τ}_{E}} \frac{15 T}{E} = M ( 1 + 5 / Q ) , \qquad ( E3 )$$

Where M is defined as

$$M ≡ \frac{{f}_{dil}}{1 + {f}_{dil} ( \frac{1}{2} \frac{〈 {T}_{α} 〉}{T} - 1 )} \qquad ( E4 )$$

In FIG. 22A, FIG. 22B, FIG. 23C, and FIG. 24D, plotted is Y versus TBE for a range of η_{He}, [symbol] A_{J}, and p_{Δ} values. While the power is fixed in each subfigure, the plasma gain is not; Q is self-consistently calculated by assuming the nominal Q=20 plasma has Σ=0.63, η_{He}=1.0, TBE=0.016, and

$${f}_{T}^{co} = 0.49 ,$$

just as assumed for the ARC-like device described in “ARC-like power plant”. It's also assumed that [symbol] T_{α} [symbol] =T in equation (E4). For each subfigure in FIG. 23, plotted is Y for a different Σ value, demonstrating how Σ improves the TBE at fixed Y.

In each subfigure in FIG. 22, and FIG. 23, the horizontal black line at Y= 10/75 indicates a rough upper bound for τ*ₕₑ/τ_{E} assuming that τ*ₕₑ/τ_{E} can have a maximum value of 10 and 15T/Σ=75, corresponding to a temperature of T=15.6 keV. For very high polarizations, there are a few TBE values that correspond to τ*ₕₑ/τ_{E}>10, but only by a very small factor of at most ˜20% for [symbol] A_{J}=1.9. It's therefore concluded that for spin-polarized plasmas with [symbol] A_{J}≤2, there are some TBE values satisfying τ*ₕₑ/τ_{E}≈10. While these higher values of τ*ₕₑ/τ_{E} may be challenging to achieve, they have been demonstrated previously, and this challenge appears relatively small compared with others in building and operating power plants that use spin-polarized fuels.

Finally, in FIG. 24, plotted is Y versus TBE, with [[COLOR]] indicating

$${F}_{T}^{in}$$

value giving the maximum TBE. Curiously, the particle confinement time always has is maximum at

$${F}_{T}^{in} = 1 / 2.$$

Running with lower

$${F}_{T}^{in}$$

gives higher IBE and lower Y.

### Appendix F. Intuition for Burn Efficiency Across Polarization

In this section, some intuition is given for how the tritium burn efficiency (TBE) can be increased strongly using spin polarization without a corresponding power decrease.

The reason that the TBE increases by much more than suggested in FIG. 7 is because at lower tritium fraction and higher [symbol] A_{J}, not only does

$${\tilde{f}}_{T}^{co}$$

decrease but the total D-T fuel injected decreases, even though the plasma electron density remains constant. To see this, consider the TBE in equation (14),

$$TBE ≡ \frac{{\dot{N}}_{T , burn}}{{\dot{N}}_{T , in}} = \frac{\overline{P}}{{F}_{T}^{in} {\dot{N}}_{Q , in}} , \qquad ( F1 )$$

Where used is P̅=\dot{N}_{T,burn}=p_{f}/E and \dot{N}_{T,in}=Fⁱⁿ+T\dot{N}_{Q,in}. Next, one obtains an expression for \dot{N}_{Q,in}, first using particle conservation from equation (22)

$${\dot{N}}_{Q , in} = 2 \overline{P} + {\dot{N}}_{Q , div} , \qquad ( F2 )$$

Next, one finds an expression for \dot{N}_{Q,div} using equation (28), giving

$${\dot{N}}_{Q , div} = \frac{\overline{P}}{{f}_{He , div} \sum } . \qquad ( F3 )$$

One finds a new expression for ƒ_{He,div} by solving equation (42)

$${f}_{He , div} = \frac{{η}_{He}}{2} {( 2 \frac{\sqrt{{\tilde{f}}_{T}^{co} ( 1 - {\tilde{f}}_{T}^{co} ) 𝒩 {A}_{J}}}{\sqrt{{p}_{Δ}}} - 1 )}^{- 1} . \qquad ( F4 )$$

Therefore, \dot{N}_{Q,div} is

$${\dot{N}}_{Q , div} = \frac{2 \overline{P}}{\sum {η}_{He}} {( 2 \frac{\sqrt{{\tilde{f}}_{T}^{co} ( 1 - {\tilde{f}}_{T}^{co} ) 𝒩 {A}_{J}}}{\sqrt{{p}_{Δ}}} - 1 )}^{- 1} . \qquad ( F5 )$$

Which substituted into equation (F2) for \dot{N}_{Q,in} gives,

$${\dot{N}}_{Q , in} = 2 \overline{P} ( 1 + \frac{1}{\sum {η}_{He}} {( 2 \frac{\sqrt{{\tilde{f}}_{T}^{co} ( 1 - {\tilde{f}}_{T}^{co} ) 𝒩 {A}_{J}}}{\sqrt{{p}_{Δ}}} - 1 )}^{- 1} ) . \qquad ( F6 )$$

Finally, one finds the TBE,

$$TBE = \frac{1}{2 {F}_{T}^{in}} \frac{1}{1 + \frac{1}{\sum {η}_{He}} {( 2 \frac{\sqrt{{\tilde{f}}_{T}^{co} ( 1 - {\tilde{f}}_{T}^{co} ) 𝒩 {A}_{J}}}{\sqrt{{p}_{Δ}}} - 1 )}^{- 1}} \qquad ( F6 )$$

It is important to note that

$${\tilde{f}}_{T}^{co} ,$$

while being on the right-hand side of equation (F7), itself depends on the TBE. However, equation (F7) is not straightforward to explicitly solve for the TBE, and therefore numerical approaches are resorted to. There is particular interest in how the TBE varies with [symbol] A_{J}. Plotted are solutions to equation (F7) for p_{Δ}=0.90 for different values of [symbol] A_{J} and Ση_{He} in FIG. 25A. The spin-polarization multiplier increases the TBE nonlinearly. Curiously, at very high ΣηHE values, here Ση_{HE}=4.0, and larger [symbol] A_{J} valyes, the derivative

$$dTBE / d {\tilde{f}}_{T}^{co}$$

can become extremely large near the maximum TBE value. Under such conditions, operating a fusion plant near the maximum TBE value would require precise

$${\tilde{f}}_{T}^{co}$$

control such that the TBE does not decrease rapidly. Furthermore, because

$${\tilde{f}}_{T}^{co}$$

will likely nave some radial dependence, the expected window of

$${\tilde{f}}_{T}^{co}$$

values across high power density regions would benefit from falling in high TBE regions.

In this exercise, it is important to recognize what is being held fixed and what is varying: in deriving the TBE in equation (F7), eliminated is ƒ_{He,div}, allowing it to vary. Shown in FIG. 25B, plasmas with higher ƒ_{He,div} have much higher TBE. While operating at higher ƒ_{He,div} may be concerning, it is important to note that the helium divertor removal rate N_{He,div} is fixed because the fusion power is constant. Therefore, the increase in ƒ_{He,div} comes from the hydrogenic divertor density n_{Q,div} falling, not from the helium divertor density increasing. Therefore, the power exhaust could be of greater concern in high TBE, high [symbol] Aⱼ plasmas due to the low hydrogen divertor density.

A consequence of allowing ƒ_{He,div} to vary is that the helium particle confinement time also increases. Fortunately, it appears that the increase is not prohibitive according to bounds placed by current experiments.

### Appendix G. Ignition Conditions

Operating with spin-polarized fuel could improve the margin of safety between stable and unstable ignited equilibria. Operating with

$${\tilde{f}}_{T}^{co} \neq 1 / 2$$

could also form a passive safety mechanism that helps prevent thermal runaway. In this appendix, performed is a simple heuristic analysis.

### G.I. Ignition Stability

The ignition conditions for a plasma with constant temperature and density profiles, is modified by tritium fraction and polarization (ignoring helium dilution effects),

$${n}_{Q} {τ}_{E} > \frac{1}{4 𝒩 {A}_{J} {\tilde{f}}_{T}^{co} ( 1 - {\tilde{f}}_{T}^{co} )} \frac{12}{〈 v \overline{σ} 〉} \frac{T}{{E}_{α}} \qquad ( G1 )$$

Where E_{α} is the fusion-borne alpha particle energy. Using that the reactivity obeys the following scaling for temperature within 10-20 keV with at most 10% error,

$$〈 v \overline{σ} 〉 = 1.1 \times {10}^{- 24} {T}^{2} {m}^{3} {s}^{- 1} , \qquad ( G2 )$$

the ignition condition is

$${n}_{Q} T {τ}_{E} > \frac{1}{4 𝒩 {A}_{J} {\tilde{f}}_{T}^{co} ( 1 - {\tilde{f}}_{T}^{co} )} 3 \times {10}^{21} {m}^{- 3} keV s \qquad ( G3 )$$

Operating at [symbol] A_{J}=1.5-1.9 with spin-polarized fuel could lower the required temperature for ignition in equation (G3) significantly. Alternatively, higher [symbol] A_{J} could be used to ignite at lower required n_{g} or τ_{E} values by choosing T≈14 keV where n_{Q}Tτ_{E} is minimized. Using higher [symbol] Aⱼ could also be used to decrease the temperature required for ignition. This could be useful in operating ignited plasmas in the thermally stable regime, given that the thermal runaway regime occurs above a threshold temperature T_{runaway}≈25 keV. For a numerical demonstration of how spin polarization and tritium burn efficiency affects the ignition condition, refer to FIG. 26 and FIG. 20.

Stability analysis shows that for an ignited plasma's temperature to be stable to thermal runaway

$$Td ln {τ}_{E} / dT < 1 - Td ln 〈 v \overline{σ} 〉 / dT . \qquad ( G3 )$$

Runaway occurs when the alpha self-heating power increases faster than the power loss decreases. This condition is not obviously modified by a fuel that is spin-polarized or has

$${\tilde{f}}_{T}^{co} \neq 1 / 2.$$

Therefore, past results obtained for the maximum D-T temperature before runaway, T_{runaway}≈25 keV, may still be accurate. Spin-polarized fuel could allow plasma ignition while ensuring that T«T_{runaway}.

### G.2. Passive Stabilization

In operating with

$${\tilde{f}}_{T}^{co} \neq 1 / 2$$

in steady state, transition to a thermal runaway process may be slowed or prevented by the following process: a temperature increase may lead to an increase in [symbol] νσ̅ [symbol] , which in turn increases

$$\vert 1 / 2 - {\tilde{f}}_{T}^{co} \vert$$

if the refueling rate is steady, which can decrease the fusion power, even at higher T. These effects are not captured by equation (G4), which would need to include a time-dependent

$${\tilde{f}}_{T}^{co} .$$

### Appendix H. Gain for SPARC-like Experiment

In this section, plotted is the plasma gain [symbol] versus tritium burn efficiency (TBE) and spin-polarization multiplier [symbol] Aⱼ for a SPARC-like fusion power plant. For ease of comparison, one uses the exact same parameters as the ARC-like fusion power plant, except decreasing the nominal plasma gain to Q=10. For completeness, also performed is the same scan but for a power plant with a nominal plasma gain of Q=40. The results are shown in FIG. 26.

It is contemplated that the various systems and methods may be implemented via a computing device. As depicted in FIG. 27, a computing device (2700) includes a processor element (2103)(e.g., a central processing unit (CPU) and/or other suitable processor(s)), a memory (2704) (e.g., random access memory (RAM), read only memory (ROM), and the like), a cooperating module/process (2705), and various input/output device (2706)(e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in hardware and/or in combination of software and hardware, e.g., using a general-purpose computer, one or more application specific integrated circuits (ASIC), and/or any other hardware equivalents. In one embodiment, the cooperating process (2705) can be loaded into memory (2704) and executed by a processor (2703) to implement the functions as discussed herein. Thus, cooperating process (2705) (including associated data structures) can be stored on a computer readable storage medium, e.g., RAM memory, magnetic or optical drive, or diskette, and the like.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the method and/or techniques described herein are invoked or otherwise provided. Instructions for invoking the methods may be stored in tangible and non-transitory computer readable medium such as fixed or removable media or memory, and/or stored within a memory within a computing device operating according to the instructions.

Thus, various embodiments for optimizing the operation of a fusion plant may be implemented via code stored on a non-transient medium in or suitable for use with a receiver (e.g., a special purpose receiver or decoding portion therein, computing device implementing a receiver function or decoding function, and so on), by a receiver or decoding portion thereof configured to perform the method such as by executing such code, by a special purpose device configured for performing the method and so on.

Referring to FIG. 28, an embodiment of a system (2800) is shown. The system (2800) may include a first system (2810) for optimizing the operation of a fusion plant. The first system (2810) may include one or more processing units (2811) operably coupled to a memory (2812), a non-transitory computer-readable storage device (2813), a communications interface (2814), and one or more input/output devices (2815)(e.g., a display, a mouse, a keyboard, etc.). The processing unit(s) may be operably coupled to additional components as needed to perform the various tasks.

As used herein, the term “processing unit” may refer to any CPU, GPU, core hardware thread, or other processing construct. As used herein, the term “thread” refers to any software or processing unit or arrangement thereof that is configured to support the concurrent execution of multiple operations.

The first system (2810) may be configured to operably communicate with one or more first remote processing units (2820) that may be used by one or more researchers/scientists (2821) who would or intend to optimize the operation of a fusion plant.

The first system (2810) may be configured to operably communicate with one or more second remote processing units (2830) that may be used by one or more plant operators (2831) who intend to operate a fusion power plant (2832).

The first system (2810) may be configured to operably communicate with one or more third remote processing units (2840). The third remote processing units may include, e.g., one or more databases or applications accessible via one or more application programming interfaces (APIs).

Various modifications may be made to the systems, methods, apparatus, mechanisms, techniques, and portions thereof described herein with respect to the various figures, such modifications being contemplated as being within the scope of the present disclosure. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present disclosure have been shown and described in detail herein, those skilled in the art can readily devise many other varied embodiments that still incorporate these teachings. Thus, while the foregoing is directed to various embodiments of the present disclosure, other and further embodiments of the present disclosure may be devised without departing from the basic scope thereof. As such, the appropriate scope of the present disclosure is to be determined according to the claims.

What is claimed is:

1. A method for optimizing the operation of a fusion plant, comprising:
selecting a preferred objective, said objective chosen to enhance the operation of a plant with a plasma comprised of deuterium-tritium fuel;
determining a target deuterium-tritium ratio based on the preferred objective; and
polarizing at least a portion of the deuterium-tritium fuel according to the preferred objective before the deuterium-tritium fuel is injected into a fusion plasma.

2. The method of claim 1, wherein the preferred objective is one of tritium burn efficiency, fusion power density, minimum tritium startup inventory, or desired power output, or a combination thereof.

3. The method of claim 1, wherein the preferred objective parameters are tritium fuel injection fraction and/or spin polarization.

4. The method of claim 2, wherein the preferred objective is minimum tritium startup inventory.

5. The method of claim 4, wherein the minimum tritium startup inventory is between 1 kg and 0.01 kg.

6. The method of claim 2, wherein the preferred tritium burn efficiency is between 10% and 40%.

7. The method of claim 1, wherein the target deuterium-tritium ratio is 55%-65% by number deuterium to 35-45% by number tritium.

8. The method of claim 7, wherein the target deuterium-tritium ratio is (i) 57% by number deuterium and 43% by number tritium or (ii) 61% by number deuterium to 39% by number tritium.

9. The method of claim 1, wherein the nuclei of at least some deuterium and/or tritium is polarized.

10. The method of claim 1, wherein at least a quarter of the deuterium-tritium fuel is polarized.

11. The method of claim 1, wherein at least three-fourths of the deuterium-tritium fuel is polarized.

12. The method of claim 1, wherein at least 95% of the deuterium-tritium fuel is polarized.

13. A fusion fuel made by the method of claim 1.

14. A system, comprising:
a non-transitory computer-readable medium carrying instructions to be executed by at least one processor, wherein the instructions are configured to perform a method for optimizing a fusion power plant, comprising:
receiving a preferred optimization objective:
improving a deuterium-tritium fuel fraction, according to the preferred optimization objective, wherein improving the deuterium-tritium fuel includes:
determining a deuterium-tritium fueling mix; and
determining target spin polarizations for injected deuterium fuel and for injected tritium fuel.

15. The system of claim 14, wherein the preferred optimization objective is at least one of tritium burn efficiency, fusion power density, and minimum startup inventory.

16. The system of claim 14, wherein the preferred optimization objective one of tritium fuel injection or spin polarization.

17. The system of claim 14, further comprising means for adjusting spin polarization of the deuterium-tritium fuel to achieve the preferred optimization objective.
